(19) United States
(12) Patent Application Publication
(10) Pub. No.: US 2015/0029322 A1
(43) Pub. Date: Jan. 29, 2015

(54) METHOD AND COMPUTATIONS FOR CALCULATING AN OPTICAL AXIS VECTOR OF AN IMAGED EYE

(71) Applicant: QUALCOMM Incorporated, San Diego, CA (US)

(72) Inventors: Richard R. Ragland, San Diego, CA (US); PhaniKumar K. Bhamidipati, San Diego, CA (US); Sten Jorgen Ludvig Dahl, San Diego, CA (US)

(73) Assignee: QUALCOMM Incorporated, San Diego, CA (US)

(21) Appl. No.: 13/948,402

(22) Filed: Jul. 23, 2013

(51) Int. Cl. G06T 7/00; G06K 9/00

(52) U.S. Cl. CPC G06T 7/0048; G06K 9/00604
USPC 348/78; 382/291

(57) ABSTRACT

Systems and methods for determining an optical axis vector of an eye in a three-axis coordinate system. An ellipse equation defining an iris disc corresponding to the eye, is determined on an XY plane of the three-axis coordinate system. A set of equations is derived based on the ellipse equation corresponding to a plurality of edge points of the iris disc in the three-axis coordinate system. An estimated iris diameter is iteratively calculated until a difference between the estimated iris diameter and a predetermined iris diameter is less than a threshold. The iterative calculation includes calculating a composite optical axis vector of the eye in the three-axis coordinate system based on solutions for the iris diameter.

### TECHNICAL FIELD

This application relates in general to methods and systems for tracking movements of a human using a digital camera, and more particularly to determining an optical axis vector of an eye in a three-axis coordinate system.

### BACKGROUND

Computer input methods and systems that track users' movements with a digital camera are generally limited to analyzing visible features, such as the hands, head, or eyes. However, such anatomical features vary significantly from one person to the next, and the apparent shapes of such visible anatomical features vary widely depending upon the orientation of the imaged anatomy, user expression, etc. Consequently, such visual tracking systems may exhibit significant positioning errors, both in recognizing the features to be tracked and in accurately determining their location and orientation in three-dimensional space.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides a method for determining an optical axis vector of an eye in a three-axis coordinate system including X, Y and Z axes. The method determines an ellipse equation defining an iris disc corresponding to the eye on an XY plane of the three-axis coordinate system. A set of equations is derived based on the ellipse equation corresponding to a plurality of edge points of the iris disc in the three-axis coordinate system. The method iteratively calculates an estimated iris diameter until a difference between the estimated iris diameter and a predetermined iris diameter is less than a threshold.

The iterative calculation includes: estimating a ray length from a spatial origin of the three-axis coordinate system to a first edge point of the plurality of edge points; solving the set of equations based on the estimated ray length to calculate a plurality of solutions; calculating the estimated iris diameter based on the solutions; and calculating an optical axis vector of the eye in the three-axis coordinate system based on the solutions. The solutions include a first solution and a second solution based on two sets of the edge points, respectively. Calculating the optical axis vector includes: calculating a first optical axis vector based on the first solution, calculating a second optical axis vector based on the second solution; and generating a composite optical axis vector based on the first optical axis vector and the second optical axis vector.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a perspective drawing of an exemplary head tracking system in accordance with some aspects of the disclosure.

FIGS. 2 and 3 are perspective and side view diagrams, respectively, of a pinhole camera model useful for defining terms and explaining details of some aspects of the disclosure.

FIG. 4A is an optical system block diagram of elements of an imaging system showing spatial reference axes.

FIG. 4B is a diagram of the image plane showing the reference axes.

FIG. 5 is a system block diagram of a computing system suitable for implementing some aspects of the disclosure.

FIG. 6 is a schematic model of human eyes viewed from the top in cross-section showing measurements and vectors pertinent to the various aspects of the disclosure.

FIG. 7 is a diagrammatic view of an image of a user's left eye in a first quadrant of the image plane.

FIG. 8 is a plot of gray-scale values in an image scanning left to right across a human eye.

FIG. 9A is a diagram of an eye in the image plane.

FIG. 9B illustrates a point-of-gaze three-axis coordinate system which includes the image plane depicted in FIG. 9A.

FIG. 10 is a diagram illustrating how the center of an eyeball is calculated by determining an intersection of the optical axis vectors resulting from the user looking in two different directions.

FIG. 11 is a process flow diagram of an exemplary method for determining the optical axis vectors of a user's eyes based on images of the user's face.

FIG. 12 is a diagram conceptually illustrating an iris disc of a user's eye captured by an image sensor.

FIG. 13 is a flowchart illustrating an algorithm for iteratively solving a set of elliptic equations to determine an optical axis-vector of an iris disc in accordance with some aspects of the disclosure.

FIG. 14 is a diagram showing a number of solution curves of a set of elliptic equations at various ray lengths for solving a set of elliptic equations.

FIG. 15 is a flowchart illustrating an algorithm for improving accuracy and reducing 3-sigma error of the calculation of an optical axis vector in accordance with some aspects of the disclosure.

FIG. 16 is a system block diagram of a mobile computing device suitable for use with various aspects of the disclosure.

FIG. 17 is a system block diagram of another computing device suitable for use with various aspects of the disclosure.

FIGS. 18, 19, and 20 are flowcharts illustrating a method of iteratively solving a set of elliptic equations to determine an optical axis of an iris disc in accordance with an aspect of the disclosure.

FIG. 21 is a flowchart illustrating an algorithm 2200 for correcting distortion of iris disc image data in accordance with an aspect of the disclosure.

FIG. 22 shows a right eye image and a plot of edge points of the right eye image for illustrating data correction algorithms in accordance with aspects of the disclosure.

FIG. 23 is a flowchart illustrating an algorithm for correcting out-of-round iris in accordance with an aspect of the disclosure.

FIG. 24 is a diagram illustrating correction on data set of an out-of-round iris in accordance with an aspect of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The word “exemplary” is used herein to mean “serving as an example, instance, or illustration.” Any implementation described herein as “exemplary” is not necessarily to be construed as preferred or advantageous over other implementations.

As used herein, the word “ellipse” includes the special case of a circle rotated in any orientation or direction in the space within an image sensor's field of view, which nearly always presents as an ellipse (as projected into images).

As used herein, a person's point-of-gaze is the point in the surrounding space that is the instantaneous object of a user's visual regard. A point-of-gaze tracker determines a vision vector for an eye of an operator. An example of a point-of-gaze tracker is disclosed in U.S. Pat. No. 5,471,542 titled, “Point-of-gaze tracker,” the entire contents of which are hereby incorporated by reference. Such a point-of-gaze tracking system enables users to provide inputs to and potentially control a computing device merely by gazing at a display. For example, U.S. Pat. No. 5,471,542 discloses a system that enables a user to control a cursor by gazing at a computer display. In this way, the cursor basically follows the user's gaze so it is always at the center of where the user is looking.

While a point-of-gaze tracker enables hands-free control of computing devices, the rapid movement of a user's eyes (such as while glancing quickly about a computer screen) can result in control difficulties and user distraction. To overcome these limitations, U.S. Patent Publication No. US2013/0083976, titled, “An Image-based Head Position Tracking Method and System,” discloses methods for tracking the movement of the user's head, permitting users to control a computer system by turning their head to face a point of interest. The entire contents of the publication are hereby incorporated by reference. Because these methods track head movement, the inputs to the computer system are not impacted by the user's rapid eye movements.

Other systems for tracking head movement have used recognizable facial features, in particular the eyes, to estimate the orientation of the user's head. However, such systems have suffered from errors resulting from the fact that human eyes vary in size and separation distance. Thus, without careful calibration to a user, such systems may be unreliable. Further, methods that depend on finding the center of the visible portion of the eyes in an image suffer from the problem that the iris is seen as a circular object only when the optical axes of the user's eyes are parallel to the optical axis of the camera; at all other angles of gaze the iris appears as an ellipse, which can result in errors in the estimation of head position and orientation.

To overcome these limitations, the movement of the user's head can be tracked based upon the location of the interior center of both eyeballs. The center of each eyeball remains in a substantially fixed location with respect to the user's skull, and thus does not substantially change shape, location, or orientation as users shift their gaze, turn their head, or change their expression. As a result, tracking the location and orientation of users' heads based on eyeball centers are not prone to the errors that plague the methods in the related art.

In overview, various aspects of the disclosure determine the location of the centers of a user's eyeballs by locating the user's eyes in a digital image, analyzing the digitized image to identify a plurality of points defining the iris ellipse (e.g., by analyzing the different light intensities in the image in the locations of the eyes), using the points to determine an optical axis vector for each eye, and projecting the optical axis vector into the eye by the radius of each eyeball. Various aspects also detail the method and computations used to accurately determine the optical axis vector for each eye. Having determined the location of both eyeball centers in a three-axis coordinate system, motion of the user's head can be easily tracked. The various aspects make use of the iris diameter and eyeball diameter, both of which may be measured by the image processing and calculation algorithms as described in detail in U.S. Patent Application Publication No. US 2013/0083976, which is incorporated by reference herein. The positions of one or both eyeball center points may therefore be tracked within a three-axis coordinate system and used to monitor head motion. Head motion—left and right, up and down, back and forth—may then be used to implement a variety of user interfaces, such as a cursor on a display screen. A system implementing the various methods generally include a video or still digital camera oriented so as to observe the face of a user, and a processor that is coupled to the camera and configured with executable software instructions to perform the various methods for analyzing the facial images and calculating the eyeball center locations. Such a system may be implemented on any of a variety of computing systems, including personal computers and mobile devices equipped with one or more suitably positioned digital cameras and a processor configured with software instructions implementing the various methods.

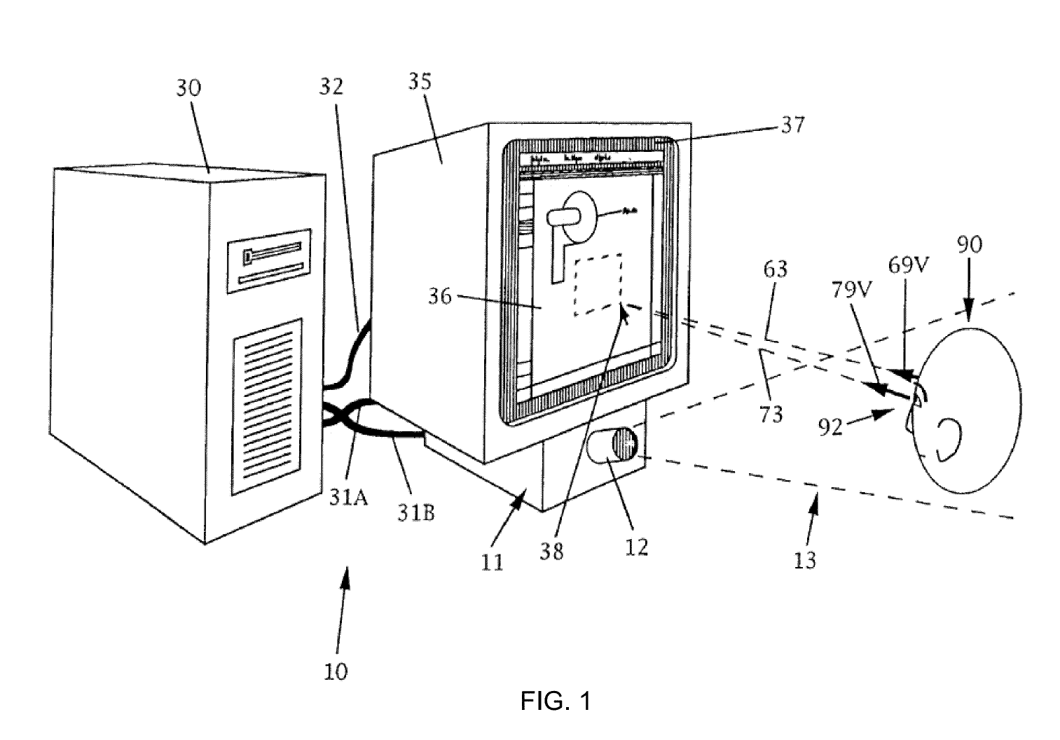

An exemplary system is shown in FIG. 1 which is used to illustrate the various aspects. Specifically, FIG. 1 shows a perspective drawing of a personal computer system, denoted generally as 10, which includes a user-imaging camera 11. The camera 11 in this illustration is physically attached to the personal computer monitor 35 so that it can image a user's head 90. The camera 11 may include a lens assembly 12, a charge coupled device (CCD) imaging array, or any digitizing imaging sensor, positioned to capture images produced by the lens 12, an image processor, a control processor, memory and camera control electronics. In the illustrated example, the computer 30 is connected by a cable 32 to the monitor 35. Based upon the size of the CCD array and magnification of the lens 12, the camera 11 will have a field-of-view 13 shown bounded by dashed lines, which in the illustrated example encompasses the user's head 90. So positioned, the camera 11 can image the user's eyes 92. In an aspect, the position and orientation of the camera 11, and more particularly the lens 12, is physically fixed relative to the monitor 35 in order to maintain a constant geometric relationship between the camera's field-of-view 13 and the monitor screen 37 at which the user will typically be looking.

The monitor screen 37 may present to the user the output of any standard software package running on the computer 10, such as the drawing environment 36 as illustrated. In the various aspects, the user is able to make inputs to the computer 10 by moving his/her head 90 which may be interpreted by the computer 30 to control the movement and position of graphical objects, such as cursor 38 in much the same way as with a manual computer mouse (not shown).

FIG. 1 also illustrates how the user may gaze at a point on the monitor screen 37. The user's visual axes 63, 73 for the left and right eyes, respectively, are represented by dashed lines. These visual axes 63, 73 (i.e., lines of sight) are not coincident with the optical axis vectors 69V and 79V, respectively, of the user's eyeballs, but both visual axes 63, 73 do align with their respective optical axes at fixed, solid angle offsets, and these solid angles are relatively small, subtending less than 5 degrees by some studies (e.g., Modeling off-axis vision—I: the OPTICAL effects of decentering visual targets or the eye's entrance pupil, by Arthur Bradley and Larry N. Thibos, School of Optometry, Indiana University, Bloomington, Ind. 47405).

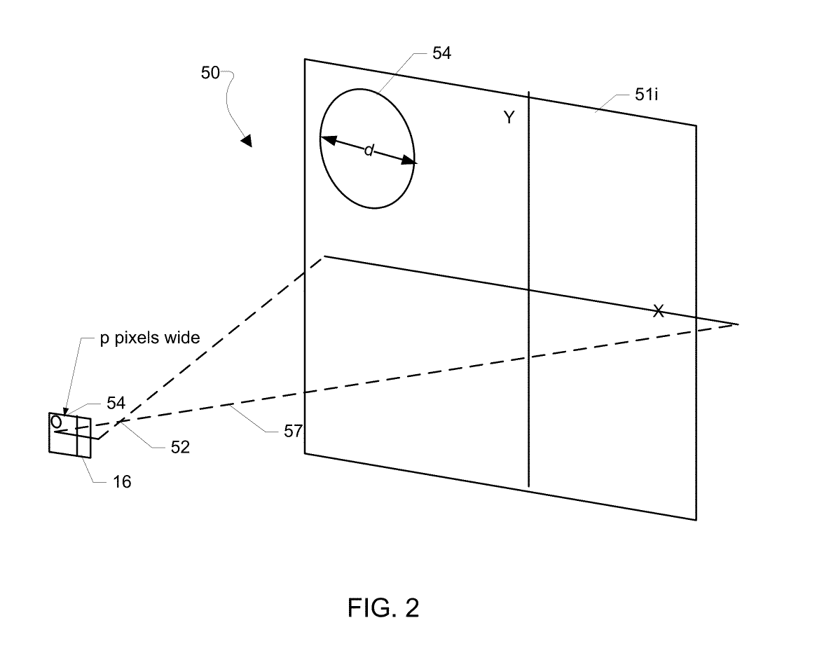

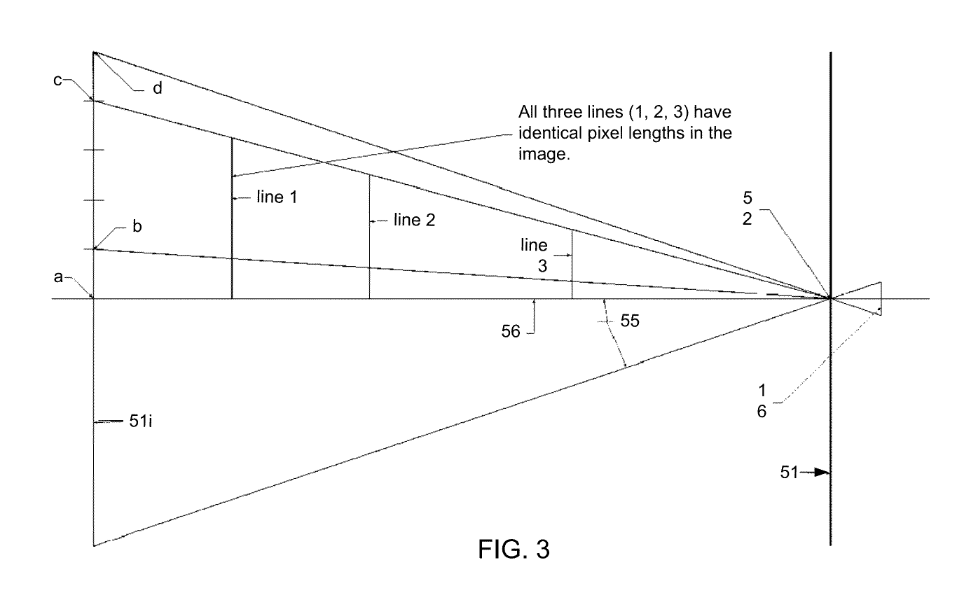

The various aspects determine the position and relative motion of a user's head within a three-axis coordinate system that is tied to the image sensor's optics. This three-axis coordinate system is illustrated in FIGS. 2 and 3, which show some of the axes and measurements used in the various aspects within a simple pinhole camera model. For ease of reference, the plane formed by the surface of the camera's imaging sensor (i.e., the plane onto which the camera's optics projects images within its field of view) is referred to herein as the “image sensor plane.” It should be clear to those well versed in optics that the pinhole camera model features a precise linear relationship between the digital camera's sensor plane and any plane in space which is parallel to the image plane.

Referring to FIGS. 2 and 3 together, in these illustrations of a pinhole camera model, the Z-axis 56 of the three axis coordinate system passes through a plane 51i which is parallel to the XY plane and the plane of the CCD, and also through the vertex 52 of the image sensor's field of view 57, and through the center point of the image sensor's CCD plane 16. The z-axis 56 is defined as coincident with the optical axis of the image sensor. The X and Y axes are perpendicular to the Z-axis 56, and the origin of all three axes (0, 0, 0) is defined to be coincident with the vertex 52 of the image sensor's field of view (FOV). For clarity, the XY plane may also be thought of as coincident with the “virtual” image plane upon which the methods described herein operate. In these figures, the extent of the field of view 57 is illustrated with dashed lines. The portion of the field of view angle 55 is the angle between the Z-axis 56 and the line of sight at the edge of the field of view 57, or one half of the angle spanned by the field of view 57. In FIG. 3 the upper half of 51i is shown divided by tick lines, as a calibration target might be marked in order to calculate a precise field of view angle from images of the target captured at different distances from the image sensor.

Referring to FIG. 2, assuming the image sensor of camera 11 is optically distortion free, or one for which any native distortion is well compensated algorithmically, any circle (such as a conveniently located iris disc within an image of a user) that lies entirely within a parallel image plane 51i in the field of view 57 will be projected into the image sensor plane 16 as a circle 54, wherever in the parallel plane it is placed. As a corollary, referring now to FIG. 3, the identical distances a-b and c-d between tick marks, must necessarily span an identical number of pixels when captured in an image, even though, as is clearly illustrated, the angle subtended by line a-b is larger than that subtended by the line c-d. Thus, this pin-hole camera model dictates that any objects entirely within a plane parallel to the plane of the image sensor's CCD 16, and within the field of view (such as those objects printed on a calibration target), are depicted in images exactly as they are located and sized on the parallel plane, in relative terms. Thus, there is a precise linear relationship between any parallel plane and the image plane. Further, assuming line1, line2, and line3 are all in the same plane—the YZ plane, for example, or the XZ plane, or any plane rotated about the Z-axis—when captured in an image, all three lines originating on the Z-axis and extending to the ray (or ray line) between c and the coordinate system origin 52, span an identical number of pixels even though, as is clearly illustrated, the three lines are of different lengths. Thus, this pin-hole camera model also dictates that any length of pixels, when measured from the center of the image, represents a distinct angle—such as the angle subtended between the z-axis and the ray intersecting the outside endpoints of lines 1, 2, and 3. Because these angles are used in various aspects of the disclosure, a calibration target may be used to find the pixel-to-angle computation function for an image sensor at any particular focus and aperture setting. In FIG. 3, there is an obvious geometric relationship between the field of view (FOV) and the target. If the target dimensions are known, along with the FOV angle, the distance to the target from the vertex 52 (0, 0, 0) along the Z-axis may be determined. Using this same geometry, the distance from the plane of the CCD to the vertex 52 may also be measured in pixels (e.g., CCD pixel dimensions in mm are specified for every CCD, which may be converted to an integer, or even partial, pixel values). Using this measure of the distance from the plane of the CCD to the vertex, the pixel-to-angle transform may be computed using a simple trigonometric function. For an exemplary image sensor used in the development of this method, at example settings for both focus and aperture, the pixel-to-angle function was determined to be:

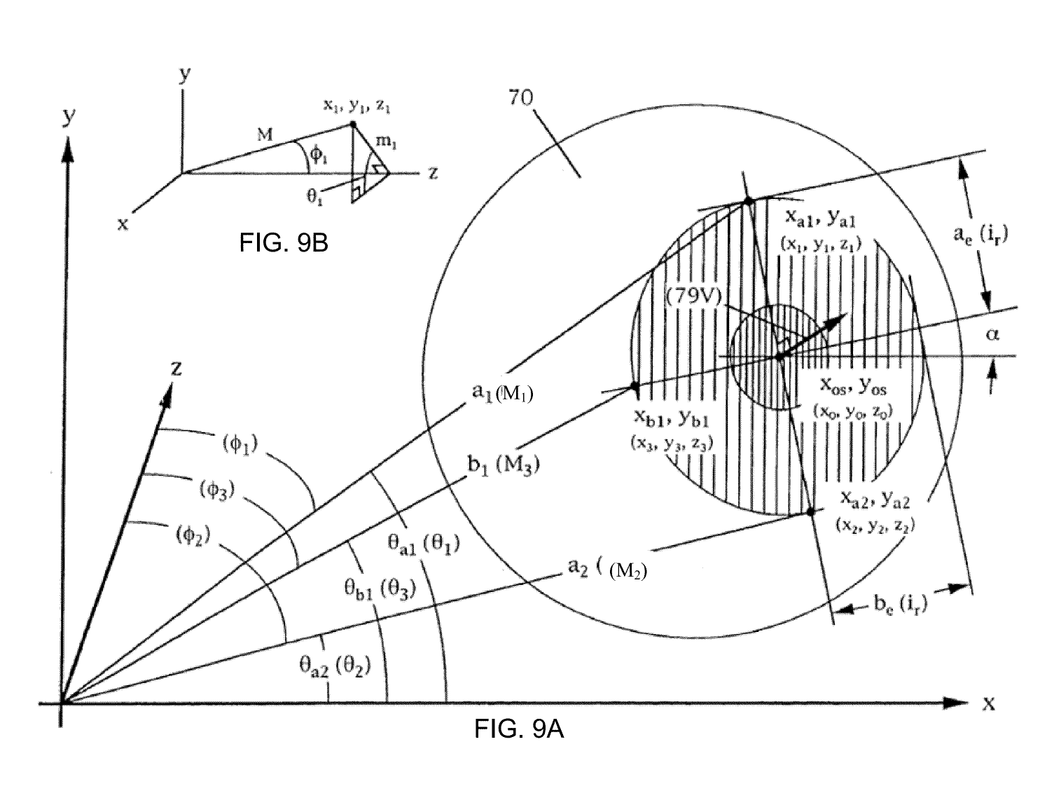

φᵢ=a tan(hᵢ/3726.06) Equation 0

Where φᵢ is the spatial angle between a ray and the z-axis (such as angles φ₁, φ₂ & φ₃ in FIG. 9A), hᵢ is the pixel length in an image from (0, 0) to any point (such as the lengths a₁, a₂ & b₁ in FIG. 9A), and 3726.06 is the length in pixels between the vertex 52 and the plane of the CCD along the z-axis. The use of this function implies the use of a “staring” image sensor (i.e., focus and aperture are not variable) in the various aspects.

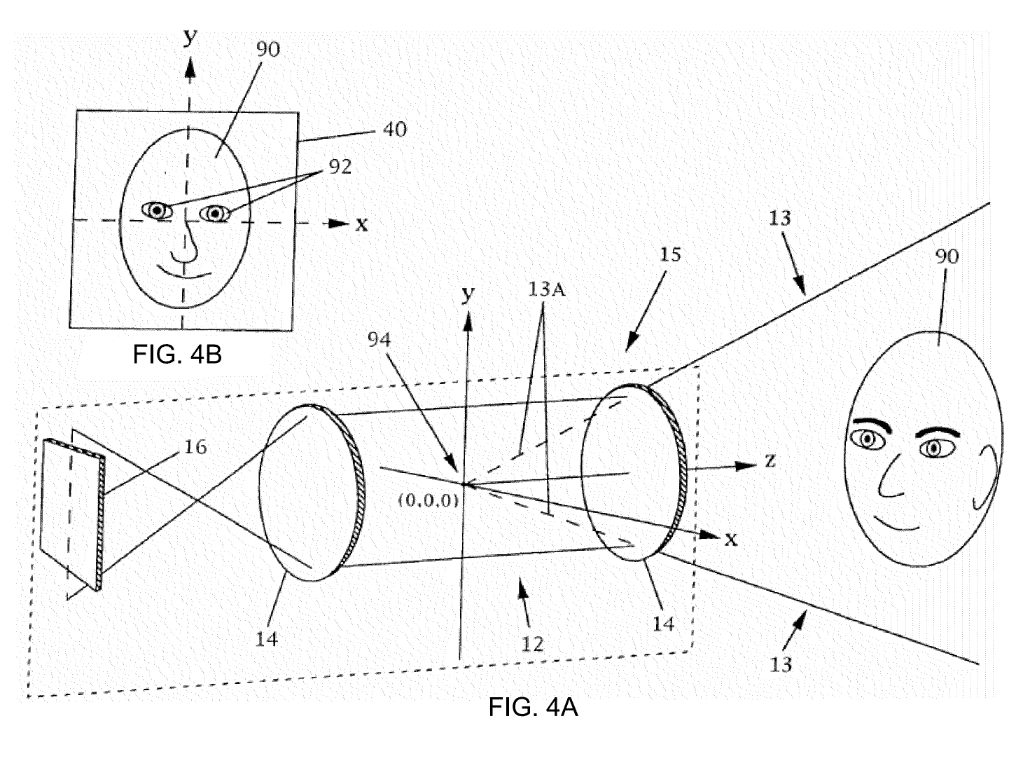

FIGS. 4A and 4B illustrate the physical relationships between a user 90 and the lens 12 which form a part of a digital imager 15 in an XYZ three-axis coordinate system 94 providing the physical frame of reference used in the calculations of the various aspects. The camera's optical lenses 14 within the lens assembly 12 transmit light, bounded by the field-of-view 13, to the CCD array 16, which forms images upon which the methods described herein operate. If light rays representing the limits of the field-of-view 13 are extended inside the lens 12 (along dashed lines 13A), they will meet in a point (0, 0, 0), which is the origin of the three-axis coordinate system. As discussed above with reference to FIGS. 2 and 3, the X and Y axes of this coordinate system are parallel to the plane 16 of the image sensor's CCD, and the Z axis is orthogonal to that plane.

Images of the three-dimensional world outside the camera, as collected by the image sensor's CCD, may be treated as a projection of that world upon a virtual image plane divided by X and Y axes, which is representatively shown as plane 40 in FIG. 4B. Inside the electronics of the digital camera 11, these objects are projected onto an array of pixel sensors (e.g., CCD elements), which output signals representative of the intensity of incident light. In the electronics of the imaging sensor, the signals from the imaging sensor are output as an array of digitized pixel (picture element) color or gray-scale values which are stored in memory. The pixel values in that array may be organized by bisecting the image plane with X and Y axes as shown, with one quarter of the pixel values located in each quadrant. Further, for the purposes of describing the various aspects, the virtual image plane may be considered to occupy a particular position in physical space; that is where the X and Y axes of the image plane exactly coincide with the X and Y axes of the XYZ three-axis coordinate system 94. Consequently, the physical relationships between all elements shown in FIG. 4A are well defined. The digital imager 15 may be physically attached to that scene which is the object of the user's visual regard (e.g., the computer's monitor screen 37 in FIG. 1). The XYZ three-axis coordinate system is defined by the image sensor's optics and the plane of its CCD 16. Although suitable 3-axis coordinate systems may be determined for other possible imaging sensor optical configurations, as described for the various aspects herein, the z-axis is coincident with the optical axis of the image sensor, and the XY plane is defined as parallel to the plane of its CCD 16. For example, the image sensor may be manufactured with its CCD mounted orthogonally to the image sensor's optical axis, which also pass through, or very near to, the center of the CCD. The image plane 40 may be, for technical convenience, placed in a position coincident with the spatial XY plane in the XYZ coordinate system.

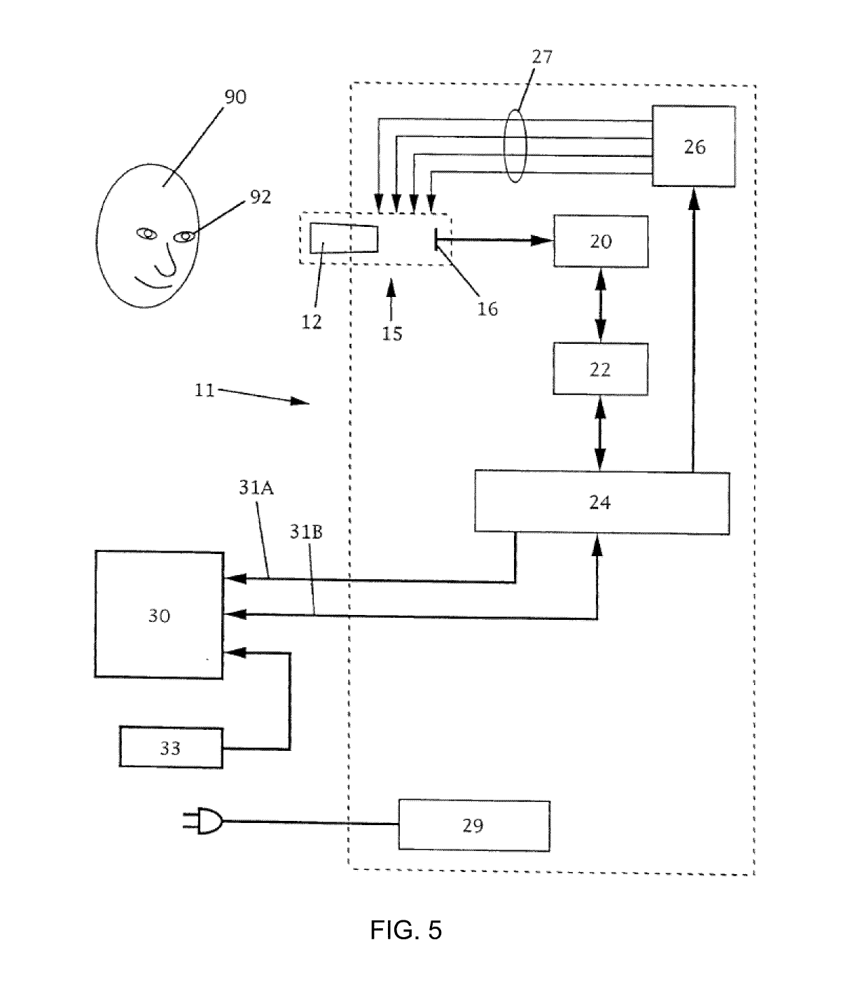

FIG. 5 is a block diagram of functional and structural elements within the digital camera 11, as well as connections to a computer 30 (or a processing system). Inside the digital camera 11, a digital imager 15 provides digital images to an image processor 20 in the form of pixel array values. The image array size depends on the array size of the image sensor's CCD 16.

A CCD sensor used to collect images for the various aspects may range, for example, in size from a few hundred pixels square to one to three thousand on a side, depending on physical constraints and the resolution required for a particular application. In an aspect, for a camera configured as shown, a larger CCD array (e.g., 5-10 megapixels) will provide sufficient resolution over a relatively wide field of view to enable a user 90 to move his/her head in and out, back and forth, as comfort or inclination requires. In various aspects, a CMOS sensor may be used to replace the CCD 16. The computer 30 and the digital camera 11 may be integrated as a single unit, for example, as a portable device such as a smartphone or a wireless phone.

When exposed to light entering the digital imager 15 through lens 12, each pixel in the CCD array accumulates an electric charge which is proportional to the intensity of the light incident upon that pixel. Each pixel's charge is gated (at a rate appropriate to the needs of the application) through an analog circuit which converts it to a voltage. The resultant voltage is proportional to the color or gray-scale value assigned to the intensity of the light falling upon that pixel. This series of gated pixel voltages is then sampled digitally and stored in memory 22 by the image processor 20. The color or gray-scale assigned to a particular intensity level is not absolute, and may depend upon the range of colors or gray-scales and light intensities allowed by the system.

Successive images may be obtained and operated on by the image processor 20. The image processor 20 may use standard image processing techniques well known in the art, such as filtering, thresholding, edge detection, segmentation, and pattern recognition to locate the user's eyes 92 within each image of the user's head 90. Such processed images may be passed to the control processor 24 which may implement the algorithms in various aspects. As described more fully below, such processing algorithms may determine the location and orientation of the irises of the user's eyes 92 within the image plane 40, mathematically determine the location and orientation of the optical axis vectors of each eye in the XYZ coordinates of the three-axis coordinate system, and use those vectors to determine the locations of the eyeball centers within the three axis coordinate system. Subsequent suitable calculations may process the eyeball center location information to enable these determinations to be used as inputs to the computer 30. In an aspect, connections 31A and 31B (e.g., SCSI, USB, Firewire, etc.) between the control processor 24 in the digital camera 11 and the computer 30 may provide an interface to mouse emulator (as one example) control software running on the computer 30 which may serve to provide inputs to the computer based on the user's head position and orientation. In some implementations, the control processor 24 may be part of the computer 30, in which case there may be no need for the connections 31A and 31B or a separate control processor 24.

In some implementations, the digital camera 11 may also include a power supply 29. The digital imager 15 may be controlled (e.g., over control lines 27) by a camera control interface 26 which may receive inputs from the control processor 24 or from the computer 30. Such camera control functions may include iris, focus, tilt and zoom.

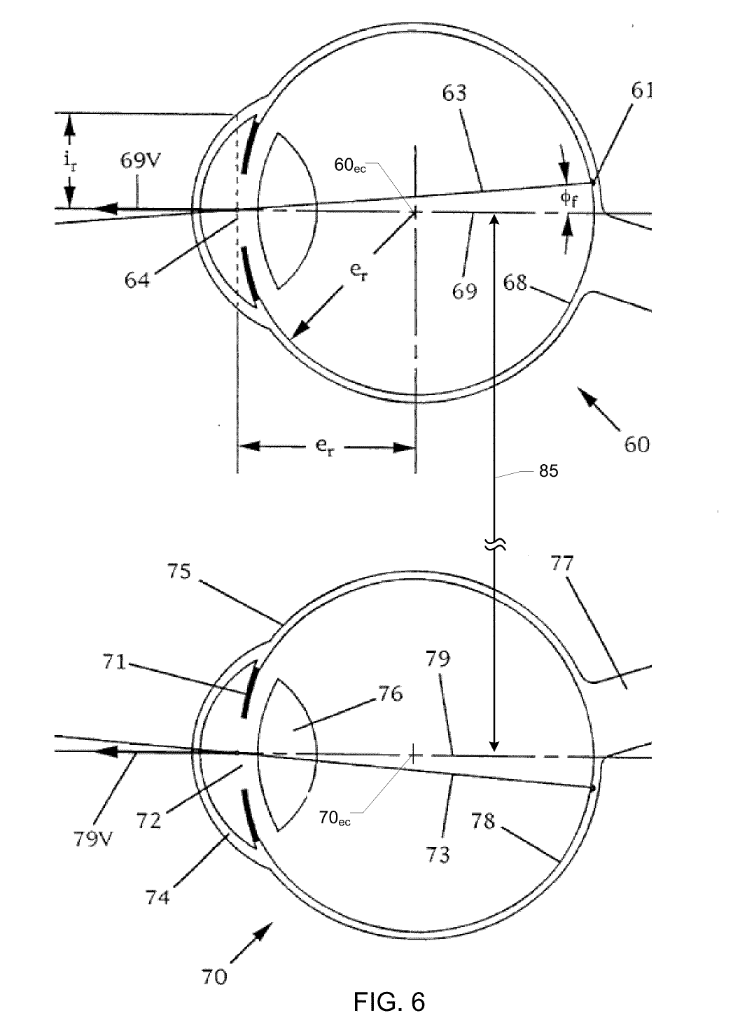

FIG. 6 schematically illustrates model cross-sections of two human eyes, denoted generally as 60 and 70, which are used to explain the basis of the algorithms employed by the various aspects of the disclosure. This eye model is primarily based upon Gullstrand's schematic eye, supplemented by generic physiological data. All of the features shown in the two cross-sections may be considered as lying in a single plane, as though a slice had been taken through an upright human head through the center of both eyes to reveal the details shown. Models shown for the right 60 and left 70 eyes are mirror images of one another. It should be noted that the inter-eyeball distance 85 is not to scale vis-à-vis the scale of the eyes 60, 70.

The illustration representing the left eye 70 shows the physiology of the human eye. The lens 76 is located just behind the iris 71 and the opening of the pupil 72. These structures are protected by the cornea 74. The sclera 75, or “white” of the eye, covers the eyeball from the edge of cornea 74 around to the optic nerve 77. Light entering the pupil 72 is gathered by the retina 78, which acts something like a CCD sensor in a digital camera, sending nerve impulses representative of images through the optic nerve 77 to the appropriate processors inside the human brain. Vision related axes include the optical axis 79 and the visual axis 73.

The illustration representing the right eye 60 shows the physical relationships between the optical axis 69, the visual axis 63, and the apparent iris disc 64 (as magnified slightly by the cornea). The fovea 61 is an area of the retina 68 where the retina's light gathering sensors are concentrated for increased resolution. As noted above, in this model, all four axes, i.e., the optical axes 69, 79 and visual axes 63, 73 of both eyes, lie in the same plane. Additionally, as shown in the illustration of the right eye 60, the optical axis 69 and the visual axis 63 intersect at the center point of the apparent iris disc 64. The optical axis 69 is orthogonal to the apparent iris disc 64, while the visual axis 63 extends from the fovea 61 through the center of the iris disc 64 to the object being viewed. In this illustration, the angle Φ_{f} between the optical and visual axes, the radius iᵣ of the apparent iris disc 64, and the internal radius eᵣ of the eyeball, represent values which differ slightly from individual to individual and are treated as variables for the discussion which follows.

Each eyeball 60, 70 is roughly spherical having an eyeball center point 60_{ec}, 70_{ec} that remains generally fixed with respect to the skull. The left and right eyes 60, 70 are separated by an inter-eyeball distance 85, which in this model is measured between the two eyeball center points 60_{ec}, 70_{ec}. Since the eyeball center points 60_{ec}, 70_{ec} remain generally fixed in position with respect to the skull, the inter-eye distance 85 defines a line of known length (following a calibration measurement with the user) which may be used to calculate or define head orientation along that particular axis once the eyeball center points 60_{ec}, 70_{ec} are located in the three axis coordinate system using the exemplary methods described below.

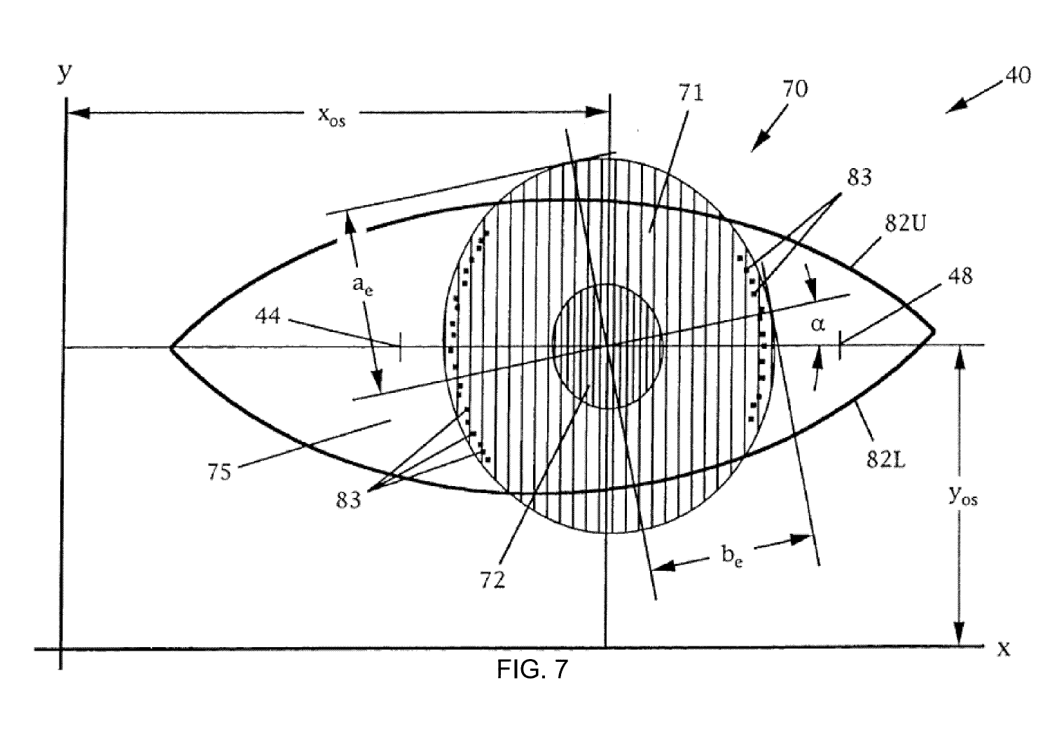

FIG. 7 is a conceptual diagram of an image a user's left eye 70 that may be captured by a digital camera 11. In this figure, the eye 70 is visible between the upper eye lid 82U and the lower eye lid 82L. The sclera 75, iris 71, and pupil 72 are indicated. Portions of the iris 71 under the eye lids 82U, 82L, although not visible to a camera, are shown here for purposes of explaining the optical axis vector formulations used in various aspects of the disclosure. The iris 71 and the pupil 72 will generally appear as an ellipse in such camera images, unless the optical axes of the user's eyes are parallel to the optical axis of the camera (defined as the z-axis of the 3-axis coordinate system), in which case the shape of the iris 71 and the pupil 72 will appear circular. The iris 71 in the image plane 40 corresponds to the apparent iris disc 64 in the model discussed above with reference to FIG. 6. The iris 71 has been modeled as a flat disc to simplify the algorithms which are described below. In images, the iris will appear as a well-defined elliptic disc.

In the various aspects, a processor (e.g., image processor 20 or control processor 24) is configured (e.g., with software instructions) to obtain and process digital images of a user's face to locate the eyes, and then process those portions of images to identify the edges of each iris. After an eye 70 has been located in the image plane by the image processor 20 or 24 using pattern recognition techniques well known in the art, the processor begins the task of pinpointing the iris boundary (i.e., the boundary between the iris and the sclera).

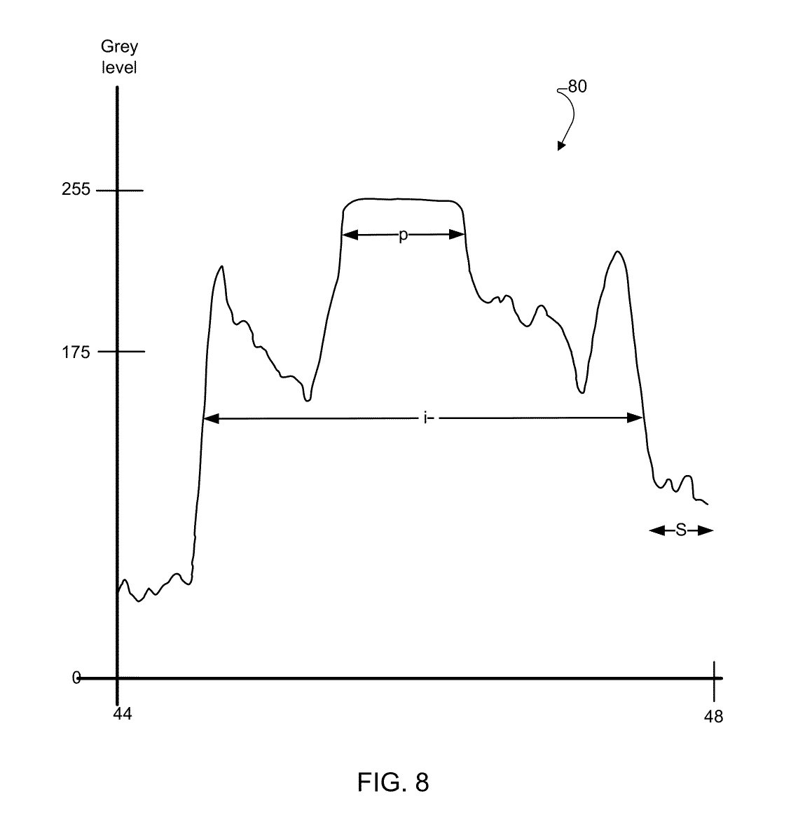

Since the sclera is white and the iris is typically much darker (e.g., brown or blue), this boundary may be recognized based upon the difference in color or gray-scale values between adjacent pixels. For example, if the gray-scale values of pixels lying along the line drawn between points 44 and 48 in FIG. 7 were plotted, the result would look something like the plot 50 shown in FIG. 8, which was taken from an actual gray-scale image of a human eye. In FIG. 8, the left scale is gray scale value, and the bottom scale represents pixel positions on the line between points 44 and 48.

The sections of plot 50 with gray-scale values representative of the sclera “s”, the iris “i”, and the pupil “p” are easily discernable. The variation in gray-levels between the outer edge of the iris and the pupil can be attributed to the “speckled” nature of the iris' coloring. The variation in mean gray-level between the sclera area near the left side 44 of plot 50 and the right 48 may be a result of shadowing by the eyelid and/or small differences in reflectance on the left and right sides of the iris. Notice that a relatively dark line of iris color, as indicated by the two outside peaks, circumscribes the iris, and offers recognizable point of reference for the iris boundary. Pixels nearest these peak values, or at points along the outer slope, e.g., at gray-level 175, may be selected algorithmically to represent the iris boundary. Given the contrast in gray-scale values between the iris and the sclera revealed in FIG. 8, known edge detection algorithms may be used to locate pixels representing the edges of the iris boundary as illustrated in FIG. 7.

Returning to FIG. 7, the process of recognizing pixel points (edge points) on the iris boundary is continued along the visible iris boundary, taking care to avoid the secondary boundaries between the irises 71 and the upper 82U and lower 82L eyelids, until a sufficient number of boundary pixel (edge) points 83 are identified. As discussed below, these boundary pixel points 83 are used to determine the equation for an ellipse which most identically fits that of the iris 71 in the image using a least squares methodology. Thus, the number of boundary pixel points 83 that is sufficient may depend upon the desired or required level of accuracy in subsequent head position calculations. Depending on the resolution desired by a particular application, these boundary pixel points 83 may be identified by single pixels located in the image plane by their X and Y distances from the origin (0, 0), for example. If greater resolution is desired than may be supplied by the CCD sensor in the system, another algorithm may be used to find inter-pixel points which are closer to the thresholds (e.g., peak values or slope) established for the conditions encountered.

The various aspects use the diameter of a user's irises in calculating the optical axis unit vectors 69V, 79V of the user's eyes. Thus, either a direct measure of a user's iris diameters may be obtained or a predetermined iris diameter may be presumed. On average, humans have an iris diameter of approximately 12 mm, with deviation about this averaged value. For many user interfaces, relational position accuracy is all that is required. For various aspects of the disclosure, an average human iris diameter of 12 mm may provide sufficient relational position accuracy of the motion of the user's head when used in the various exemplary calculations. For some applications, such as user interfaces requiring greater accuracy, an accurate measure of the user's iris diameters may be required. Accurate measures may be obtained by direct physical measurement, such as by a researcher using sized templates held close to the user's eyes, and using his/her own judgment as to which template circle diameter most closely matches the user's irises. Alternatively, iris diameters may be measured indirectly, such as by using a calibration process in which an initial estimate of iris diameter is refined in order to improve the estimation of the optical axis vectors. In the discussion that follows, all processes, procedures, and calculations are indifferent as to whether the user's optical axis vectors are determined by using an iris diameter estimate, a relatively precise measurement of the user's irises, or by any other suitable means.

The elliptic function for the iris boundary (as it appears in the image plane 40) is defined by five parameters: the x-offset (xₒₛ) which is the X axis distance to the center of the iris ellipse; the y-offset (yₒₛ), which is the Y axis distance to the center of the iris ellipse; aₑ, which is ½ the length of the major axis; bₑ, which is ½ the length of the minor axis; and α, the rotation angle of the ellipse with respect to the X axis. These distances are represented in pixels because the ellipse fit is performed on pixel points in the image plane 40. All five of these ellipse defining parameters may be calculated using a least-squares fit of the general elliptic function to those boundary pixel points 83 identified by the algorithm discussed above.

These points are henceforth generically denoted by the couplet (xᵢ, yᵢ). The general elliptic function is defined as:

$$\frac{[ sin α ( {y}_{i} - {y}_{os} ) + cos {α ( {x}_{i} - {x}_{os} ]}^{2}}{{b}_{e}^{2}} + \frac{[ cos α ( {y}_{i} - {y}_{os} ) - sin {α ( {x}_{i} - {x}_{os} ]}^{2}}{{a}_{e}^{2}} = 1 \qquad Equation 1$$

When simplified, this equation fits the form:

Axᵢ²+Bxᵢyᵢ+Cyᵢ²+Dxᵢ+Eyᵢ+F=0 Equation 2

where: B²−4AC<0. For the least-squares fit, this equation may be recast in the form:

$${y}_{i}^{2} = {A}^{′} {x}_{i}^{2} + {B}^{′} {x}_{i} {y}_{i} + {D}^{′} {x}_{i} + {E}^{′} {y}_{i} + {F}^{′} \\ where \text{:} \\ {A}^{′} = \frac{- ( {b}_{e}^{2} {sin}^{2} α + {a}_{c}^{2} {cos}^{2} α )}{{a}_{e}^{2} {sin}^{2} α + {b}_{e}^{2} {cos}^{2} α} = - A / C \\ {B}^{′} = \frac{- [ ( {a}_{e}^{2} - {b}_{e}^{2} ) sin 2 α ]}{C} = - B / C \\ {D}^{′} = \frac{2 {Ax}_{os} + {By}_{os}}{C} = - D / C \\ {E}^{′} = \frac{2 {Cy}_{os} + {Bx}_{os}}{C} = - E / C \\ {F}^{′} = \frac{{a}_{e}^{2} {b}_{e}^{2} - {Ax}_{os}^{2} - {Bx}_{i} {y}_{i} - {Cy}_{os}^{2}}{C} = - F / C \qquad Equation set 3$$

The five parameters defining the iris ellipse may be determined from a least-squares fit of the iris boundary points to this function. For example, fifty to a hundred points, spread along the boundaries on both sides of the iris, will provide excellent precision to support the algorithms.

From the list of boundary points (xᵢ,yᵢ), the following calculations may be made:

Σyᵢ²=a

Σxᵢ²=b

Σxᵢyᵢ=c

Σxᵢ=d

Σyᵢ=e

Σyᵢ³=f

Σxᵢ²yᵢ=g

Σxᵢyᵢ²=h

Σxᵢ³=m

Σxᵢyᵢ³=p

Σxᵢ³yᵢ=r

Σxᵢ²yᵢ²=s

Σxᵢ⁴=t Equation set 4

and # of pixel points=n.

For the least squares fit, the following five equations are used to solve for the five unknown coefficients, A′, B′, D′, E′, and F′, from the general elliptic function:

a=A′b+B′c+D′d+E′e+F′n

f=A′g+B′h+D′c+E′a+F′e

h=A′m+B′g+D′b+E′c+F′d

p=A′r+B′s+D′g+E′h+F′c

s=A′t+B′r+D′m+Kg+F′b Equation set 5

Solving this system of equations by elimination, the following lists of calculations may be performed:

a′=fn−ae

b′=gn−be

c′=hn−ce

d′=cn−de

e′=an−e²

f′=hn−ad

g′=mn−bd

h′=gn−cd

m′=bn−d²

n′=pn−ac

p′=rn−bc

r′=sn−c²

s′=sn−ab

t′=tn−b²

a″=e′f′−a′d′

b″=e′g′−b′d′

c=e′h′−c′d′

d″=e′m′−d′²

e″=e′n′−a′c′

f″=e′p′−b′c′

g″=e′r′−c′²

h″=e′s′−a′b′

m″=e′t′−b′²

a′″=d″e″−a″c″

b′″=d″f″−b″c″

c′″=d″g″−c″²

d′″=d″h″−a″b″

e′″=d″m″−b″² Equation set 6

Further, solving:

$${A}^{′} = \frac{{c}^{′′′} {d}^{′′′} - {a}^{′′′} {b}^{′′′}}{{c}^{′′′} {e}^{′′′} - {b}^{′′′2}} \\ {B}^{′} = \frac{{a}^{′′′} - {A}^{′} {b}^{′′′}}{{c}^{′′′}} \\ {D}^{′} = \frac{{a}^{″} - {A}^{′} {b}^{″} - {B}^{′} {c}^{″}}{{d}^{″}} \\ {E}^{′} = \frac{{a}^{′} - {A}^{′} {b}^{′} - {B}^{′} {c}^{′} - {D}^{′} {d}^{′}}{{e}^{′}} \\ {F}^{′} = \frac{a - {A}^{′} b - {B}^{′} c - {D}^{′} d - {E}^{′} e}{n} \qquad Equation set 7$$

Finally, by substituting:

$$2 α = arctan [ {B}^{′} / ( {A}^{′} + 1 ) ] \\ {y}_{os} = \frac{2 {A}^{′} {E}^{′} - {D}^{′} ( {A}^{′} + 1 ) tan 2 α}{4 {A}^{′} + {( {A}^{′} + 1 )}^{2} {tan}^{2} 2 α} \\ {x}_{os} = \frac{( {A}^{′} + 1 ) {y}_{os} tan 2 α + {D}^{′}}{- 2 {A}^{′}} \\ {a}_{e}^{2} = \frac{( {F}^{′} - {A}^{′} {x}_{os}^{2} + {y}_{os}^{2} ) cos 2 α - ( {A}^{′} + 1 ) {x}_{os} {y}_{os} sin 2 α}{{A}^{′} {sin}^{2} α + {cos}^{2} α} \\ {b}_{e}^{2} = \frac{- [ \begin{matrix}( {F}^{′} - {A}^{′} {x}_{os}^{2} + {y}_{os}^{2} ) cos 2 α - \\ ( {A}^{′} + 1 ) {x}_{os} {y}_{os} sin 2 α\end{matrix} ]}{{sin}^{2} α + {A}^{′} {cos}^{2} α} \qquad Equation set 8$$

These solutions yield the location and orientation of the iris ellipse within the coordinate system of the image plane from the measurable parameters obtained by processing of the image of the user's head obtained by the digital camera. For example, the operations involved in solving these equations utilize fewer than 700 multiply and divide instructions for each eye, and even a slow processor performing one multiply or divide per microsecond can complete these calculations in less than one millisecond in real-time.

Once the five parameters have been calculated for the iris ellipse, these parameters may be used to determine the location and orientation of the optical axis 79, which is defined by the optical axis vector 79V pointing out from the center of the apparent iris disc (i.e., the center of the pupil). An exemplary method for calculating the optical axis unit vectors 69V, 79V is described below; however, the disclosure is not limited to this method, and other arithmetic algorithms may be employed for determining these vectors.

In an exemplary method for calculating the optical axis unit vector 79V, the method first calculates positions (in the referenced XYZ coordinate system) for at least three points on the iris disc, including the center. Once these points are found, a simple cross-product of the vectors between the center of the iris disc and two other points on that disc will produce the optical axis unit vector 79V.

FIG. 9A illustrates the left eyeball 70 (as it might appear magnified, and stripped of all surrounding tissue) in the image plane 40 of the digital imager 15 in an aspect. The Z axis has been added to serve as a reference to FIG. 9B. Note that four points, e.g., three on the edge of the apparent iris disc and one at the center, have been identified. Each point has been denoted by a coordinate couplet and triplet, e.g., (xₒₛ, yₒₛ) and (x₀, y₀, z₀). The couplet associates the point to the image plane; the triplet associates the point to the XYZ coordinate system defined by the sensor's optical system. All symbols in FIG. 9A bounded by parentheses represent spatial values within the three-axis coordinate system. At the start of the calculation, none of the triplets are known. The couplet (xₒₛ, yₒₛ) is known. The other three may be easily calculated from the five iris parameters using trigonometry. For example, it is seen that: xₐ₁=xₒₛ−aₑ sin α, and yₐ₁=yₒₛ+aₑ cos α. The distance in the image plane (in pixels) between the origin (0, 0) and each point on the edge of the apparent iris disc is simply the hypotenuse of the triangle formed by the point's X and Y coordinates: b₁=(x_{b1}²+y_{b1}²)^{1/2}, for example.

Because the axes in the image plane are placed as defined, i.e., coincident with the spatial x and y axes, and because the Z axis is defined as coincident with the optical axis of the image sensor, any line in the image which passes through the origin represents not only a distance measured in pixels, but also a spatial angle, i.e., one which can be directly related to the field-of-view of the image sensor's optics by some function, fₒₚ. All of the distances a₁, a₂, and b₁ in FIGS. 9A and 9B, therefore, also represent unique angles in the XYZ three-axis coordinate system, as subtending between related rays (Mᵢ) and the z-axis.

FIG. 9B helps clarify the physical relationships that exist between one of the spatial points identified with the iris disc, (x₁, y₁, z₁) in this case, and its corresponding point in the image plane, (xₐ₁, yₐ₁). FIG. 9B depicts point (x₁, y₁, z₁) as located and measured in the image plane's attendant XYZ coordinate system. As shown, a right triangle can be constructed where the hypotenuse M connects the origin in the inset diagram with the point (x₁, y₁, z₁), and where side m₁ intersects the Z axis at a distance z₁ from the origin (0, 0, 0). The projection of m₁ through the sensor's optics would produce line a₁ as it appears in the image plane. The spatial angle φ₁ between M and the Z axis is therefore related to a₁ by fₒₚ, i.e., φ₁=fₒₚ (a₁). Additionally, 1) the extended plane defined by this right triangle (M, m₁, Z axis) also contains line a₁, and 2) the XZ plane in the XYZ coordinate system also contains the X axis shown in the image plane. Therefore, the spatial angle θ₁ formed by the intersection of these two planes is also equal to the plane angle θₐ₁ in the image plane formed by the intersection of a₁ and the x axis. The lines a₂ and b₁ are related to angles φ₂, θ₂, θₐ₂ and φ₃, θ₃, θ_{b1} in a similar fashion.

The iris disc in space is circular when its optical axis is parallel to the z-axis, not elliptic as it most often appears when projected into the image plane. Further, the distance in space between the two edge points (x₁, y₁, z₁) and (x₂, y₂, z₂) is equivalent to twice the iris radius iᵣ. Additionally, the spatial distance between (x₀, y₀, z₀) and any of the edge points is identically iᵣ, and the distance between the b-axis edge point (x₃, y₃, z₃) and either of the other two edge points is ✓2iᵣ. It is also clear, therefore, that:

iᵣ²=(x₁−x₀)²+(y₁−y₀)²+(z₁−z₀)²

iᵣ²=(x₃−x₀)²+(y₃−y₀)²+(z₃−z₀)²

2iᵣ²=(x₁−x₃)²+(y₁−y₃)²+(z₁−z₃)²

2iᵣ²=(x₂−x₃)²+(y₂−y₃)²+(z₂−z₃)²

4iᵣ²=(x₁−x₂)²+(y₁−y₂)²+(z₁−z₂)² Equation set 9

Further, with reference to FIG. 9A, each of the coordinates which define a point in the image may be expressed in terms of M, an unknown ray length, and the two known angles associated with each of them—φ₁ and θₐ₁ for a₁; φ₂ and θa₂ for a₂—thus:

x₀=M₀ sin φ₀ cos θ₀=Aₓ₀M₀(where Aₓ₀=sin φ₀ cos θ₀)

y₀=M₀ sin φ₀ sin θ₀=A_{y0}M₀

z₀=M₀ cos φ₀=A_{z0}M₀

x₁=M₁ sin φ₁ cos θₐ₁=Aₓ₁M₁

y₁=M₁ sin φ₁ sin θₐ₁=A_{y1}M₁

z₁=M₁ cos φ₁=A_{z1}M₁

x₂=M₂ sin φ₂ cos θₐ₂=Aₓ₂M₂

y₂=M₂ sin φ₂ sin θₐ₂=A_{y2}M₂

z₂=M₂ cos φ₂=A_{z2}M₂

x₃=M₃ sin φ₃ cos θ_{b1}=Aₓ₃M₃

y₃=M₃ sin φ₃ sin θ_{b1}=A_{y3}M₃

z₃=M₃ cos φ₃=A_{z3}M₃ Equation set 10

Therefore, with reference to Equation set 9:

iᵣ²=(Aₓ₁M₁−Aₓ₀M₀)²+(A_{y1}M₁−A_{y0}M₀)²+(A_{z1}M₁−A_{z0}M₀)² Equation 11

iᵣ²=(Aₓ₃M₃−Aₓ₀M₀)²+(A_{y3}M₃−A_{y0}M₀)²+(A_{z3}M₃−A_{z0}M₀)² Equation 12

2iᵣ²=(Aₓ₁M₁−Aₓ₃M₃)²+(A_{y1}M₁−A_{y3}M₃)²+(A_{z1}M₁−A_{z3}M₃)² Equation 13

2iᵣ²=(Aₓ₂M₂−Aₓ₃M₃)²+(A_{y2}M₂−A_{y3}M₃)²+(A_{z2}M₂−A_{z3}M₃)² Equation 14

4iᵣ²=(Aₓ₁M₁−Aₓ₂M₂)²+(A_{y1}M₁−A_{y2}M₂)²+(A_{z1}M₁−A_{z2}M₂)² Equation 15

This system of five quadratic equations in four unknowns may be solved in a variety of ways, the simplest of which appears to be reducing the equation set to three equations, carefully selected to provide a reasonably swift iterative solution. For example, the first three equations (11, 12 & 13) are such a set. If a reasonable first estimate of ray length M₀ may be determined, the first two equations reduce to simple quadratics in a single unknown, which may then be factored, and the third equation may be employed to check the answers obtained. An iterative process may then be employed to successively reduce errors in the iterated solutions to arrive at the correct values for ray length M₀, M₁, and M₃ relatively quickly. Likewise, the last three equations in set 11 (13, 14 and 15) are another set. Because these three equations measure the largest available “features” of the iris disc ellipse, this is the exemplary method described in detail herein.

In general, any solution algorithm sets a value for the iris radius iᵣ to proceed. If the iris radius iᵣ for this particular user is a value already known, such as a measured value stored in memory, then this value may be used to solve the equation set. If iᵣ is not known, an estimated value, such as the value of the average human iris radius (e.g., about 12 mm), may be used to solve the equation set.

In one aspect, Equations 13, 14, and 15 may be selected. To solve these equations relatively easily, an estimate of the ray length M₃ is made, which renders Equations 13 and 14 simple quadratics in a single unknown, which can then be factored. To compute an estimate of M₃, the fact that length aₑ (in pixels) corresponds directly to iᵣ (in mm) may be used. As discussed above with respect to FIGS. 2 and 3, when thought of as originating at (0, 0) in the image, the pixel length of aₑ corresponds to a specific angle, φₐₑ, which may be calculated using Equation 0. This angle subtends a ray that may be thought of as intersecting a line of length iᵣ in space extending from the z-axis outward, within a plane parallel to the XY plane, at a distance zₐₑ. It is a simple task to compute this distance thus:

zₐₑ=iᵣ/tan φₐₑ Equation 16

And(since zᵢ=Mᵢ cos φᵢ):

M₃≈zₐₑ/cos φ₃ Equation 17

This distance is a reasonable first estimate of M₃, and may serve as the starting point for the iterative process outlined by Equations 11-15. First, this initial estimate of M₃ is substituted into Equation 13 and solved:

2iᵣ²=(Aₓ₁²+A_{y1}²+A_{z1}²)M₁²−2M₃(Aₓ₁Aₓ₃+A_{y1}A_{y3}+A_{z1}A_{z3})M₁+(Aₓ₃²+A_{y3}²+A_{z3}²)M₃²,

where:

B₁(Aₓ₁²+A_{y1}²+A_{z1}²)

C₁=2M₃(Aₓ₁Aₓ₃+A_{y1}A_{y3}+A_{z1}A_{z3})

D₁=(Aₓ₃²+A_{y3}²+A_{z3}²)M₃²−2iᵣ²,and

M₁²−(C₁/B₁)M₁+D₁/B₁=0.

This equation is factored to find the roots (M₁₁, M₁₂), either one of which may be the correct M₁. The same process may be employed to solve Equation 14 for M₂, and check all four root combinations (M₁₁/M₂₁, M₁₂/M₂₁, M₁₁/M₂₂, M₁₂/M₂₂) using Equation 15. One of the four combinations will produce a result for Equation 15 which is closer than the other three to the value of 4iᵣ². If this result equals 4iᵣ² (or very nearly equals to the degree required for the application), the computation is complete and the correct values for M₁, M₂, and M₃ have been found. Otherwise, the estimate for M₃ may be iterated and may proceed in the same manner until a result for Equation 15 equals 4iᵣ², which result is accomplished with the correct values for M₁, M₂, and M₃. Since the progression of M₃ estimates demonstrated predictable outcomes during development of this method, relatively few are needed to arrive at a result sufficiently identical to 4iᵣ², assuming a reasonably sophisticated algorithmic process.

Using Equation set 10, along with the computed values of M₁, M₂, and M₃, the spatial coordinates associated with these points in the image (x₁, y₁, z₁), (x₂, y₂, z₂), (x₃, y₃, z₃) may be determined. Since the disc center point is halfway between the two a-axis endpoints, (x₁, y₁, z₁) and (x₂, y₂, z₂), the disc center point (x₀, y₀, z₀) may be determined.

x₀=(x₁+x₂)/2

y₀=(y₁+y₂)/2

z₀=(z₁+z₂)/2 Equation set 18

Using (x₀,y₀,z₀), (x₁,y₁,z₁) [or (x₂,y₂,z₂)], and (x₃,y₃,z₃), the iris disc vector associated with (x₀,y₀,z₀) may be computed, which is the cross product of the vector from (x₀,y₀,z₀) to (x₁,y₁,z₁) and the vector from (x₀,y₀,z₀) to (x₃,y₃,z₃). This iris disc vector is the optical axis vector for that eye of the user, as seen in the image.

Using the algorithms described above to obtain the optical axis vectors of a user's eyes, the centers of the eyeballs may be calculated. If the eyeball radius eᵣ is known, the eyeball center point 70_{ec} is simply the point on the optical axis unit vector 79V projection 102 into the eyeball that is one radius eᵣ distance from the pupil. If the eyeball radius eᵣ is not known, it may be readily calculated based on the calculated optical axis vectors.

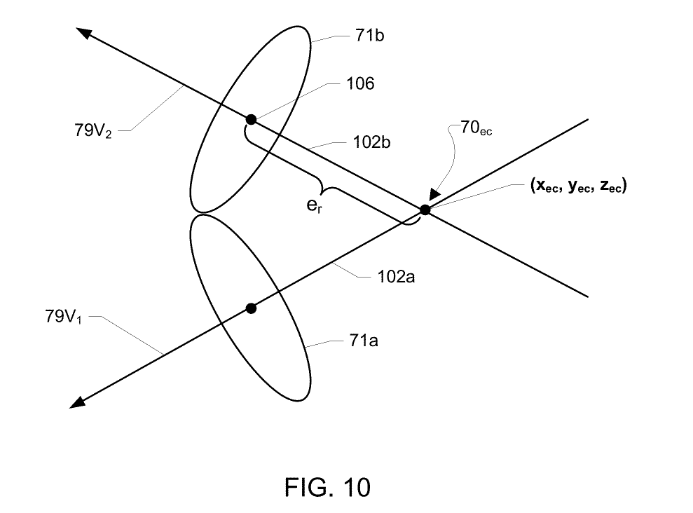

Referring to FIG. 10, the eyeball center point 70_{ec} may be identified as the intersection of all optical axis vectors determined when the user is gazing in different directions with the head held still. Using methods described above, the optical axis vectors 79V₁, 79V₂ may be determined for at least two discrete iris disc 71ₐ, 71_{b} positions or gaze directions as illustrated in FIG. 10. These different vectors 79V₁, 79V₂ may be stored in memory and then compared to define a common point or intersection that constitutes the eyeball center 70_{ec}. In order to increase the accuracy of the center location determination, several optical axis vectors 79V₁, 79V₂ may be determined for widely displaced gaze angles. For example, the user may be seated at a calibration station or rest his/her chin on a calibration stand that holds the head still during the process. A display may be employed to prompt the user to look at various spots on the screen in order to alter the user's gaze point. Such gaze targets may be presented on the screen in order to obtain a plurality of iris disc positions reflecting gaze points on the screen which differ widely (e.g., the display's left edge, along the centerline, right edge, top and bottom edges, and the four corners). Widely differing gaze points will provide optical axis vectors with relatively large solid angle differences. During this process, the user's head must be kept relatively still. This could be accomplished by asking the user to rest his/her chin upon a brace of some kind, or to place his/her head in a mechanical fixture of some kind. However, the exemplary methods are robust enough to tolerate some small motion of the user's head, so that merely instructing the user to keep his/her head still may provide a sufficiently accurate result. Since the process requires very brief images, the process may be accomplished relatively quickly. Typically, this method for calculating the eyeball radius will be incorporated in an initial calibration procedure for each user. Nevertheless, this method is equally compatible with adaptive techniques, which could be employed to calculate a user's eyeball radius on the fly, refining the retained value as small errors (e.g., due to the user's indeterminate motion) are reduced over time. Using an initial calibration procedure may mitigate indeterminate motion by the user, resulting relatively rapidly in an accurate radius value calculation.

When the collected optical axis vectors 79V₁, 79V₂ are extended mathematically within the volume occupied by the user's eyeball (i.e., beneath the visible surface of the eye shown as vector portions 102ₐ, 102_{b}), the vectors will appear to intersect at, or very near to, a single point in space. This point may be presumed to indicate the position of the eyeballs center point 70_{ec}. Considering the minor errors pertaining to any particular optical axis calculation (e.g., eyelids may be more open or more closed, different iris edge points are used for widely differing gaze points, etc.), it is unlikely that any two optical axis extension lines 102ₐ, 102b will precisely intersect. Therefore, in order to find a single point nearest to the intersection for all of the collected extension lines, statistical analysis or a “bundling” function or similar process may be employed to identify a single most likely center point. An exemplary bundling function is disclosed in “SBA: A Software Package for Generic Sparse Bundle Adjustment,” by Manolis I. A. Lourakis and Antonis A. Argyros, Transactions on Mathematical Software, Vol. 36, No. 1, Article 2, March 2009. That article describes a publicly available C/C++ software package which performs a highly efficient sparse bundle adjustment for sets of data similar to a collection of optical axis vector extension lines. Other similar functions and processes may be used to find the eyeball center point from a collection of optical axis vectors. Whichever function or process is employed, the output is a best estimate of the three-axis position of the eyeball center (x_{ec}, y_{ec}, z_{ec}).

Once the eyeball center point 70_{ec} (x_{ec}, y_{ec}, z_{ec}) has been found, the distance from that point to the origin point (e.g., the center of the pupil 106) for one or more of the collected optical axis vectors may be averaged to obtain the radius value eᵣ for the user's eyeball. Once the eyeball radius eᵣ is obtained, the value may be stored in memory and used to find the eyeball center point 70_{ec} for any subsequent iris disc position based on a calculated optical axis vector, whether or not the user's head has moved, and wherever the user is looking at the time. To do this, a line segment originating at the pupil may be extended along the optical axis vector extension lines 102a, 102b by the length of the radius value eᵣ to find the eyeball center point 70_{ec}. In this manner, successive eyeball center points 70_{ec} may be tracked over time in order to track the motion of the user's head.

Since the eyeball center points 60_{ec}, 70_{ec} remain a fixed distance apart, i.e., inter-eye distance 85, defining a line across the user's head, the calculations of the eyeball centers using these methods provides a robust and reliable measure of a user's head position with respect to left/right rotation, left/right tilting, and even up/down motion. Although sequential relational positioning of these eyeball centers is certainly adequate to embody many user interfaces—a cursor on a display, for example—well known facial recognition methods may be further used to determine a user's chin position (e.g., position of the chin with respect to the user's eyeballs) in order to more accurately track up/down (e.g., nodding) head orientation and motions. Whether by means of eyeball centers only, or together with other facial cues such as chin position, accurate tracking of head position may be used for a wide variety of applications. Some examples of useful applications include providing a hands-free mechanism for providing input commands to a computer, such as to move and control a cursor on a display screen, a telerobotic sensor for providing directional commands to cameras in a telerobotic system and/or tracking user head movements for scientific and medical studies. In general, any system that can benefit from accurately determining head position information may use the various aspects of the disclosure.

The computational methods described above can easily be implemented within a variety of computing devices that couple to or include a digital camera positioned to image a user. In overview, such methods will involve obtaining an image of the user's face, such as while the user is using a computing device, locating the user's eyes and identifying the boundary of the user's iris in each image. Then, using the equations described above, the computing device can process the portion of the user's image including the irises using known or estimated iris diameters and previously determined eyeball diameters in order to locate the centers of the user's eyeballs. With the eyeball centers located in a three-axis coordinate system, various computerized methods may then determine a location and orientation of the user's head, which may be used as an input, such as to control position of a cursor or selection tool.

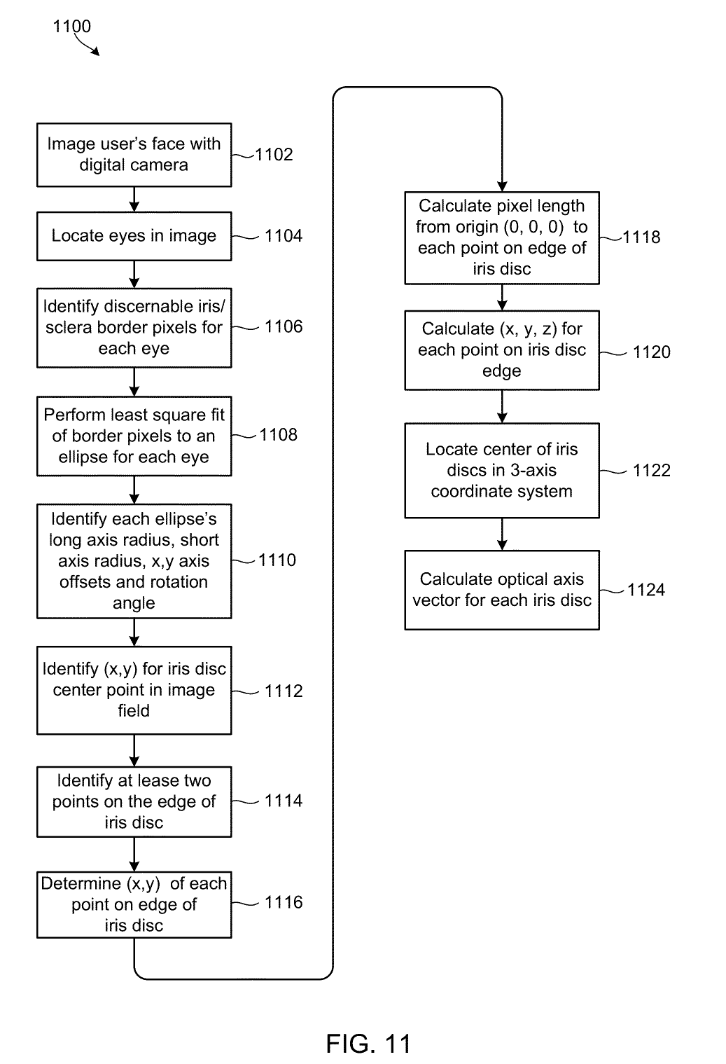

An exemplary method 1100 for determining an optical axis of a user's eye is illustrated in FIG. 11. In various aspects, the iris radius (or diameter) and eyeball spherical radius (or diameter) may be presumed, or measured values which are stored in memory. Any suitable methods may be utilized to obtain these values that are then used in the method 1100 for determining the optical axis illustrated in FIG. 11. In method 1100 in step 1102, a digital camera may be used to obtain a digital image of the user's face. In step 1104, the obtained image may be processed normally to locate the eyes of the user within the image. Any known method for locating the eyes of an individual within a digital image may be used for this process. In step 1106, the portion of the obtained image containing the user's eyes may be processed to identify the discernible portion of the iris-sclera boundary (i.e., that portion not covered by the eyelids). Since the sclera is white and the iris is another color (e.g., brown, blue, green, or violet), this boundary identification step may use any of a number of image processing techniques to identify pixels at or near an abrupt color or gray-shade transition. This process may also involve pixel section algorithms to select those pixels in the obtained image which best represent the iris-to-sclera boundary. Further, this process may identify numerous pixels within the obtained user image which best correspond to the iris-to-sclera boundary, such as illustrated in FIG. 7.

In step 1108, a processor of the computing device may perform a least squares fit of the identified iris-to-sclera boundary pixels to an ellipse equation in order to identify the ellipse defining parameters in step 1110. Such ellipse defining parameters may include the ellipse long (major) axis radius, short (minor) axis radius, X and Y coordinates of axis offset locations, angle of rotation and axis of rotation (i.e., line coordinates of the long axis). In step 1112 the processor may identify the (x, y) coordinates of the center point of the apparent iris disc in the image field, which are equal to the coordinates of axis offset locations (xₒₛ, yₒₛ). In step 1114, the (x, y) coordinates of at least two points on the edge of the apparent iris disc may be calculated using the ellipse defining parameters from step 1110. In step 1116, the distance in pixels between the origin (0,0) and each point on the apparent iris disc edge in the image plane may be calculated as the hypotenuse of the triangle formed by the (x, y) coordinates of the point. In step 1118, the pixel length of a ray from the origin (0, 0, 0) to the points on the iris disc edge may be determined using the iris radius and the spatial angle between the ray and the Z-axis, as described above in detail with respect to FIGS. 9A and 9B. In step 1120, the spatial coordinates (x, y, z) of the points on the iris disc edge may be calculated. In step 1122, assuming points on the iris disc edge are positioned so that a line between them is the iris diameter, the spatial coordinates of the center point of the iris disc may be calculated (since the iris disc is a circle in space, not an ellipse as it generally appears when projected into an image). In step 1124, the iris disc vector may be calculated as the cross product of the vector from (x₀, y₀, z₀) to (x₁, y₁, z₁) and the vector from (x₀, y₀, z₀) to (x₃, y₃, z₃).

These calculations determine the orientation and location of the iris disc in the three axis coordinate system. In other aspects, the processor may extend the calculated optical axis vector into the eyeball region. Given the geometry of the eyeball, this line passes through the center of the eyeball, as illustrated in FIG. 6. Using a known or presumed radius of the eyeball, the center of the eyeball may be calculated in the three axis coordinate system as the distance from the center of the iris along the extended optical axis vector. Accordingly, the center of the eyeball within the three axis coordinate system may be determined.

Steps 1104 through 1124 may be performed by the computing device processor for both eyes—and may be performed for both eyes more or less in parallel—in order to determine the location of both eyeball centers within the three axis coordinate system. As a result of these calculations, the computing device processor will have the three-axis coordinates of two points within the head of the user that do not vary with expression or gaze angle, and thus accurately reflect the location and orientation of the user's head in space with respect to the digital camera. This information may be used to determine the orientation of the user's head within the three axis coordinate system. Using the two eyeball center points, the processor can determine user head position in terms of X, Y, Z location, right/left rotation, up/down motion, and left/right tilt angle. If a more accurate up/down rotation orientation is desired by an application, such vertical head rotation may be determined using known facial recognition techniques which may image the top of the head or bottom of the chin (or other anatomical feature), which may be compared to the line between the two eyeball centers.

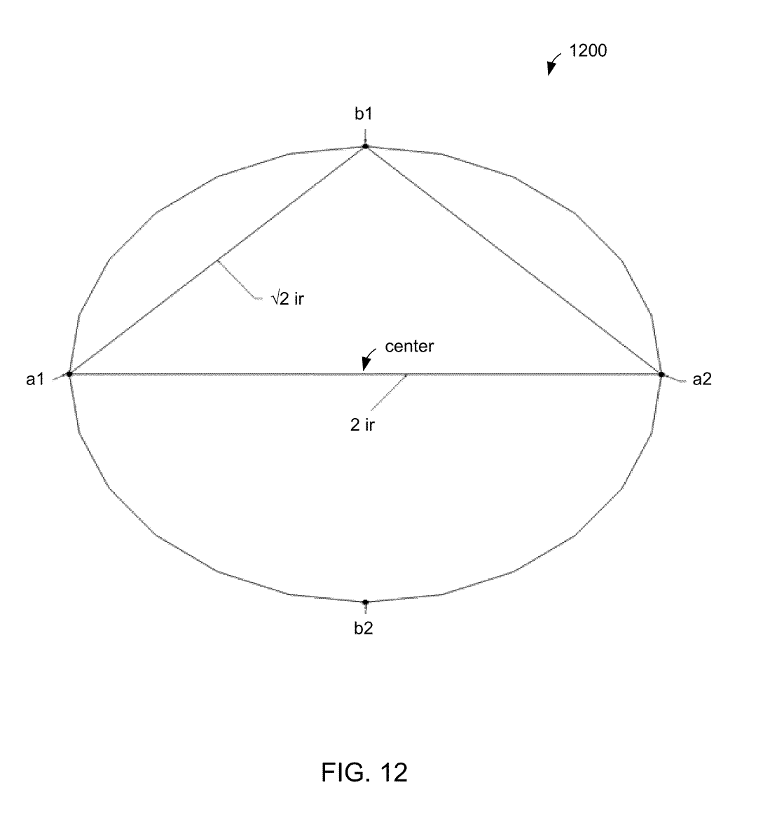

In various aspects, an algorithm that can be used to iteratively solve the Equations 11 to 15 in order to determine an optical axis vector of a user's eye will be described below in more detail in reference to an iris disc 1200 conceptually illustrated in FIG. 12. The iris disc 1200 may correspond to the left eyeball 70 in FIG. 9A and can be represented using the elliptic Equation 1. Four edge points a₁, a₂, b₁, and b₂ are illustrated in FIG. 12. The end points a₁ and a₂ are the end points of a major axis (a-axis) of the iris disc 1200, and the end points b₁ and b₂ are the end points of a minor axis (b-axis) of the iris disc 1200. The corresponding spatial distance between the disc's two a-axis endpoints (a₁, a₂) are known to be 2iᵣ (i.e., twice the iris radius). The spatial distance between the two b-axis endpoints (b₁, b₂) is also 2iᵣ. Therefore, the spatial distance between a₁ and b₁ (or a₂ and b₁, a₁ and b₂, or a₂ and b₂) is equal to ✓2iᵣ.

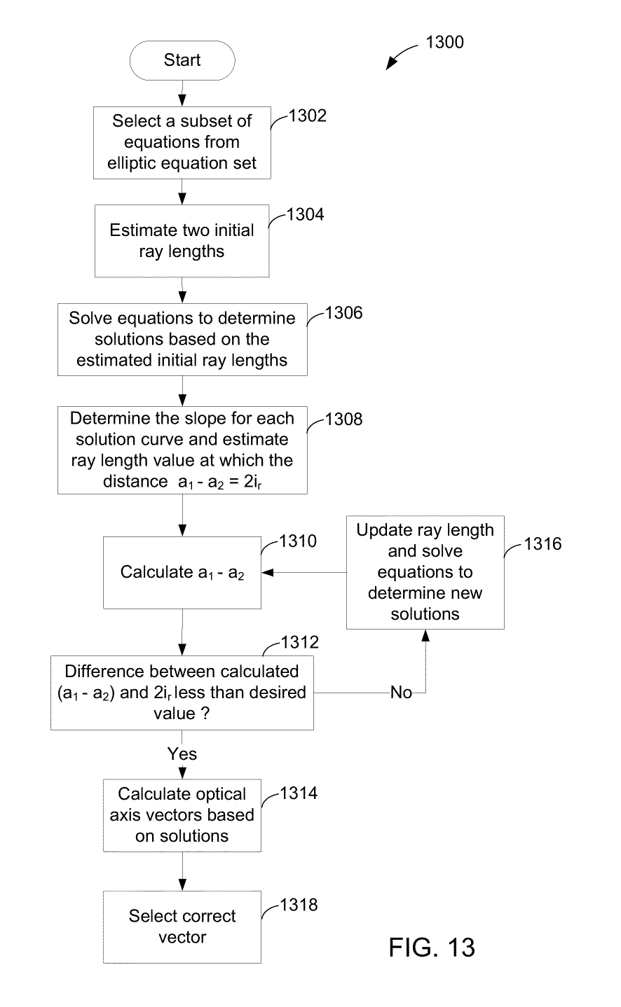

FIG. 13 is a flowchart illustrating an algorithm 1300 for iteratively solving the set of Equations 11 to 15 in accordance with an aspect of the disclosure. In a step 1302, a subset of the Equations 11 to 15 is selected for solving. For example, Equations 11, 12, and 13 (M0, M1, M2) or Equations 13, 14, and 15 (M1, M2, M3) may be selected as the subset. By way of illustration and not limitation, Equations 13, 14, and 15 are selected as the subset and repeated below for the following discussion.

2iᵣ²=(Aₓ₁M₁−Aₓ₃M₃)²+(A_{y1}M₁−A_{y3}M₃)²+(A_{z1}M₁−A_{z3}M₃)² Equation 13

2iᵣ²=(Aₓ₂M₂−Aₓ₃M₃)²+(A_{y2}M₂−A_{y3}M₃)²+(A_{z2}M₂−A_{z3}M₃)² Equation 14

4iᵣ²=(Aₓ₁M₁−Aₓ₂M₂)²+(A_{y1}M₁−A_{y2}M₂)²+(A_{z1}M₁−A_{z2}M₂)² Equation 15

This subset of equations corresponds to the edge points in FIG. 12 representing the largest available composite feature set (e.g., a-axis diameter and b-axis radius). That is, the equations correspond to the edge points a₁, a₂, and b₁, or edge points a₁, a₂, and b₂ for example. In the following discussion, it is assumed that the equations correspond to the edge points a₁, a₂, and b₁. In a step 1304, two initial estimates for the ray length M₃ leading from the spatial origin to the spatial point corresponding to b₁ [i.e., (0, 0, 0) to (x_{b1}, y_{b1}, z_{b1})] are estimated. For each estimated M₃ value, the first two Equations 13 and 14 can be reduced to simple quadratics, which can be factored. In a step 1306, the equations are solved to determine the solutions for each ray length estimate. There are two solutions for each equation where the spatial distance from (x_{b1}, y_{b1}, z_{b1}) to (xₐ₁, yₐ₁, zₐ₁) and, subsequently, from (x_{b1}, y_{b1}, z_{b1}) to (xₐ₂, yₐ₂, zₐ₂) is identically √2iᵣ. The third Equation 15 (relating a₁ to a₂) is then solved to determine the spatial distance between a₁ and a₂, which is then compared with 2iᵣ. Because the first two equations each have two possible solutions, there are four solutions to the third equation (i.e., all combinations of the solutions found for the first two equations).

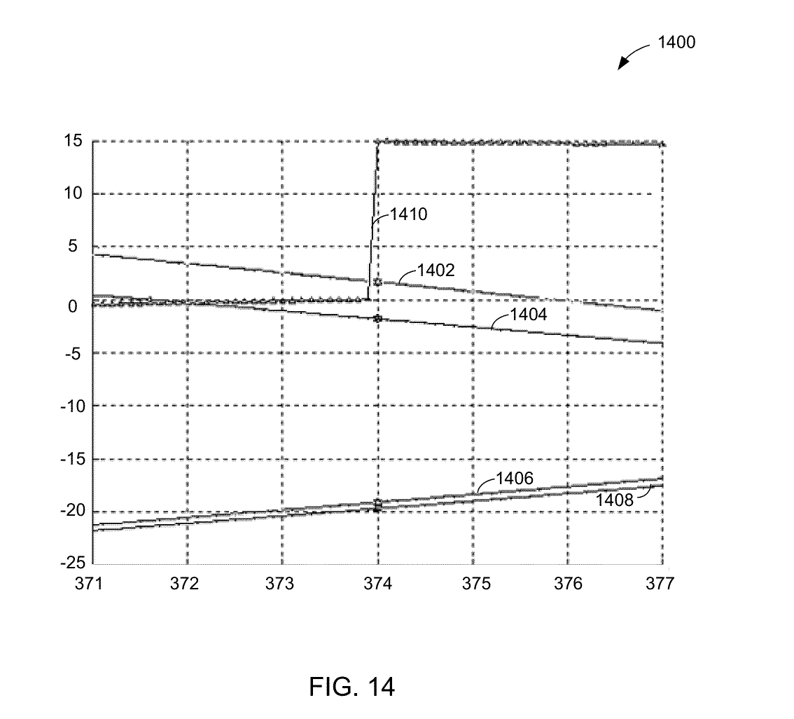

In one example, FIG. 14 is a diagram showing a number of solution curves (1402, 1404, 1406, 1408) for the four solutions using edge points a₁/a₂/b₁ at varying ray length M₃ estimates from 371 mm to 377 mm (horizontal axis). The values along the vertical axis show the difference between these solutions (at any given ray length estimate) and the value of 2iᵣ. As is shown in FIG. 14, a curve 1402 and a curve 1404 both cross zero (when the solutions are equal to 2iᵣ). A curve 1410 shows the value of the x-vector component calculated for the curve 1402 or the curve 1404 when their values are close to zero. In this particular example, the iris disc is known to be rotated in y direction only, with the disc diameter around which it is rotated being parallel to the x-axis. For this particular iris disc, therefore, x-vector components for the optical axis vector should be zero. As shown in FIG. 14, when the curve 1404 is nearer zero than the curve 1402, the curve 1410 (x-vector component) hovers near zero. For this iris disc, therefore, the correct solution for edge points a₁/a₂/b₁ occurs at the value of M₃ where curve 1404 crosses zero.

The curves shown in FIG. 14 are typical for iris disc ellipses captured in images, as illustrated by their cardinal points (e.g., a₁, a₂, b₁, b₂). Although the four solution curves (1402, 1404, 1406, and 1408) appear fairly linear in FIG. 14, they are actually the four arms of two parabolic curves: a first parabolic curve (1404/1406) and a second parabolic curve (1402/1408). In this case, each pair of arms meet very close to the solution points where the estimated ray length (M₃) value is more than 385. Thus, only two of the four apparent solutions cross zero. At larger ray length values, after the point where the parabolic arms meet, these solutions produce imaginary components, defining the absolute upper bound for ray length estimates that produce potentially useful solutions.

For all iris disc ellipses, one or the other of the two solutions that cross zero (when equal to 2iᵣ) will be the “correct” solution. In should be noted that a “composite” vector solution to be described in more detail below is significantly more accurate than this “correct” solution, which may be considered as an interim or initial solution. For the solutions shown in FIG. 14, of the two that cross zero, using the a priori context that the x-vector component should be near zero, it can be determined that the solution of the curve 1404 is “correct.” Further, when considering the “incorrect” solution of the curve 1402, the x-vector component (curve 1410) is obviously wrong, having a value near 15, which has the subject's optical axis vector pointing considerably outside the area the subject might be viewing (e.g., a display). In working systems, where no a priori knowledge about disc position and/or orientation is available to the application's algorithmic process, this rather stark differentiation between the two potentially “correct” solutions holds, and serves to guide the process to select the “correct” solution. In working systems, solutions which provide no useful purpose (e.g., subject is not viewing the display), or are starkly disconnected from previous solutions, are wrong or not useful. This judgment can be easily bolstered algorithmically as well, for example, when the alternate solution does connect contextually with previous solutions or the presumed object of the subject's gaze.

Referring back to FIG. 13, in a step 1308, the slopes of the four curves are calculated based on the first two estimated values of the ray length M₃. Then, the two solution curves (e.g., curves 1402, 1404) that cross zero are identified as well as the approximate ray length (M₃) value at which the spatial distance between a₁ and a₂ should be close to 2iᵣ in accordance with the processes described above. In a step 1310, the spatial distance (estimated iris diameter) between the points a₁ and a₂ is calculated based on the estimated ray length value. In a step 1312, if the difference between the estimated iris diameter and the value 2iᵣ is less than a desired value or threshold (e.g., 0.005 mm), the algorithm continues to a step 1314; otherwise, it continues to a step 1316. In step 1316, the ray length value is updated or adjusted, and the equations are solved again based on the updated ray length value. The algorithm 1300 repeats the steps 1310, 1312, and 1316 until the difference between the estimated iris diameter and 2iᵣ is acceptably small (e.g., less than the desired threshold). That is, the algorithm 1300 iterates and recalculates using another ray length estimate until the desired accuracy is reached.

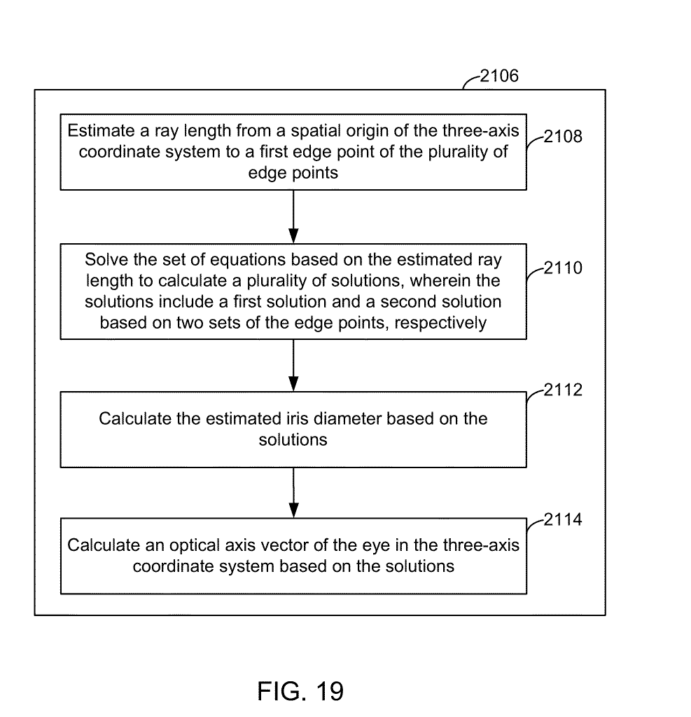

As an example, referring to FIG. 14, an initial ray length can be estimated to be 374 mm, followed by an iteration at 375 mm. From these two solution sets, the algorithm 1300 can readily determine that the curves 1402 and 1404 will cross zero close to 371.6 mm and 375.9 mm (step 1308). From there, another few iterations of the algorithm (steps 1310, 1312, and 1316) can reduce the difference error to be less than 0.005 mm, for example. In step 1314, the optical axis vectors are calculated based on the two solutions determined in the previous steps. In step 1318, the optical axis vectors obtained in the calculations are compared contextually to geometric expectations and past solutions, and the “correct” vector is thus identified. Referring back to FIG. 19, once the xyz coordinates of the three edge points are determined based on the “correct” solution, the center (x₀, y₀, z₀) of the iris disc can be easily calculated as [(xₐ₁+xₐ₂)/2, (yₐ₁+yₐ₂)/2, (zₐ₁+zₐ₂)/2], and the optical axis vector is determined by a cross product involving the center point (x₀, y₀, z₀), b₁, and either a₁ or a₂.

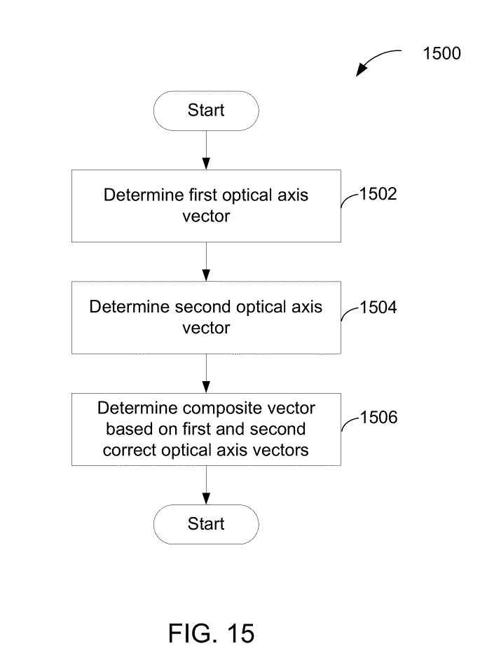

Analysis of numerous virtual iris disc solutions (based upon disc edge data created by projecting perfectly circular iris-sized disc edges into virtual images), shows that the “correct” solution for either half of the iris disc ellipse (e.g., a₁/a₂/b₁ or a₁/a₂/b₂ in FIG. 12) alone may be insufficiently accurate for some applications. Further analysis of the same data demonstrates that the simple process of averaging the “correct” vector obtained with a₁/a₂/b₁ and the “correct” vector obtained with a₁/a₂/b₂ produces a composite vector with significant improvements in both accuracy and variance (3-sigma error). FIG. 15 is a flowchart illustrating an algorithm 1500 for improving accuracy and reducing 3-sigma error of the calculated optical axis vector in accordance with an aspect. In a step 1502, a first optical axis vector is determined for the triangle defined by the edge points a₁, a₂, and b₁ (see FIG. 12) utilizing the algorithm 1300 as described above. In a step 1504, a second optical axis vector is determined for the triangle defined by a₁, a₂, and b₂ (see FIG. 12) utilizing the algorithm 1300. Then, in a step 1506, a composite optical axis vector is determined based on the first and second optical axis vectors. For example, the x, y and z components (the origin as well) for the first and second optical axis vectors are averaged to determine the final composite vector. The steps 1502 and 1504 may be performed in different orders or concurrently.

While the exemplary calculation methods are described herein and in the drawings as being accomplished in a rectilinear three-dimensional coordinate system, aspects of the disclosure may also be implemented in a similar manner in other types of three-dimensional coordinate systems including a spherical coordinate systems and an elliptical coordinate system.

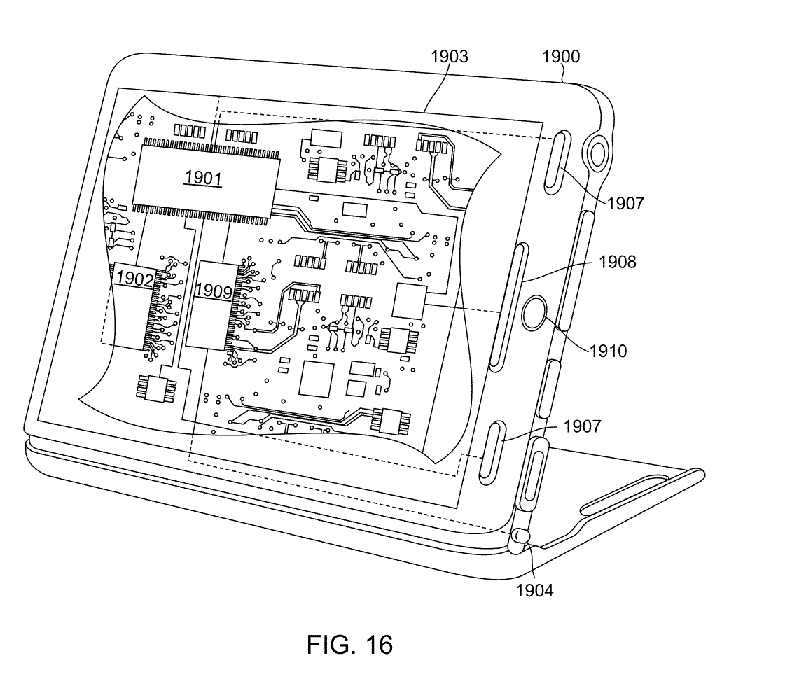

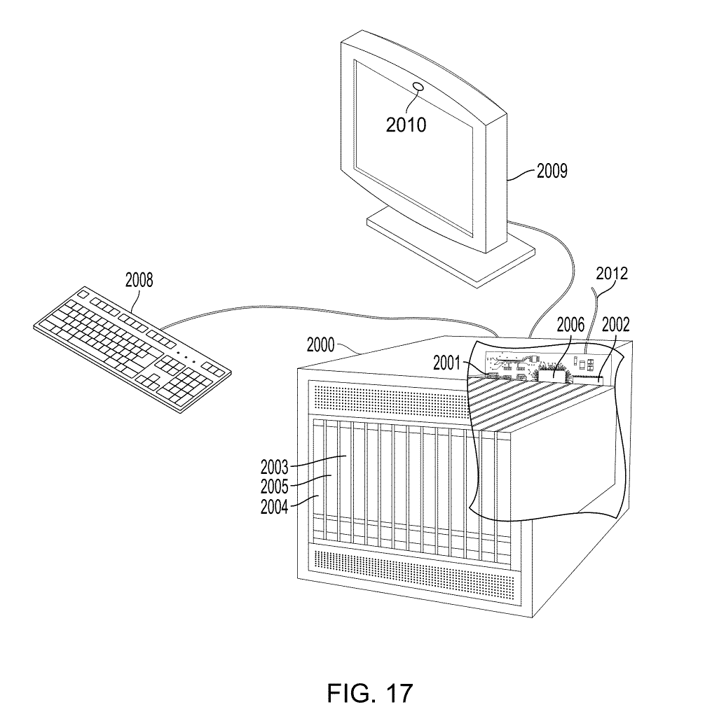

The various aspects may be implemented on a variety of conventional computer systems, such as a mobile device 1900 illustrated in FIG. 16 and a personal computer system 2000 illustrated in FIG. 17. FIG. 16 shows a mobile device 1900 suitable for use with any of the aspects of the disclosure. The mobile device 1900 may include a processor 1901 coupled to a digital camera 1910 capable of imaging a user's face when the device is held in a suitable position. The processor 1901 may also be coupled to internal memory 1902, a display 1903, and other components, such as a speaker 1908. In some implementations, the mobile device 1900 may include an antenna 1904 for sending and receiving electromagnetic radiation that may be connected to a wireless data link and/or cellular telephone transceiver 1905 coupled to the processor 1901. Receiver devices 1900 typically also include menu selection buttons 1907 or rocker switches for receiving user inputs. In various aspects, the mobile device 1900 may be a mobile phone, a smartphone, or a tablet computer.

Referring to FIG. 17, a computer system 2000 typically includes a processor 2001 coupled to volatile memory 2002 and a large capacity nonvolatile memory, such as a disk drive 2003. The computer system 2000 may include a display 2009 coupled to the processor 2001, as well as a digital camera (e.g., a CCD camera) 2010 positioned to be able to image a user's face. The computer system 2000 may also include a floppy disc drive, compact disc (CD) or DVD disc drive 2004 coupled to the processor 2001. The computer system 2000 may also include network access ports 2006 coupled to the processor 2001 for establishing data connections with a network 2012, such as a local area network coupled to other broadcast system computers and servers. Computer system 2000 may also include other user interfaces, such as a keyboard 2008.

The processors 1901, 2001 may be any programmable microprocessor, microcomputer or multiple processor chip or chips that may be configured by software instructions (applications) to perform a variety of functions, including the functions of the various aspects described herein. In some mobile receiver devices, multiple processors 2001 may be provided, such as one processor dedicated to wireless communication functions and one processor dedicated to running other applications. Typically, software applications may be stored in the internal memory 1902, 2002, and 2003 before they are accessed and loaded into the processor 1901, 2001. The processor 1901, 2001 may include internal memory sufficient to store the application software instructions.

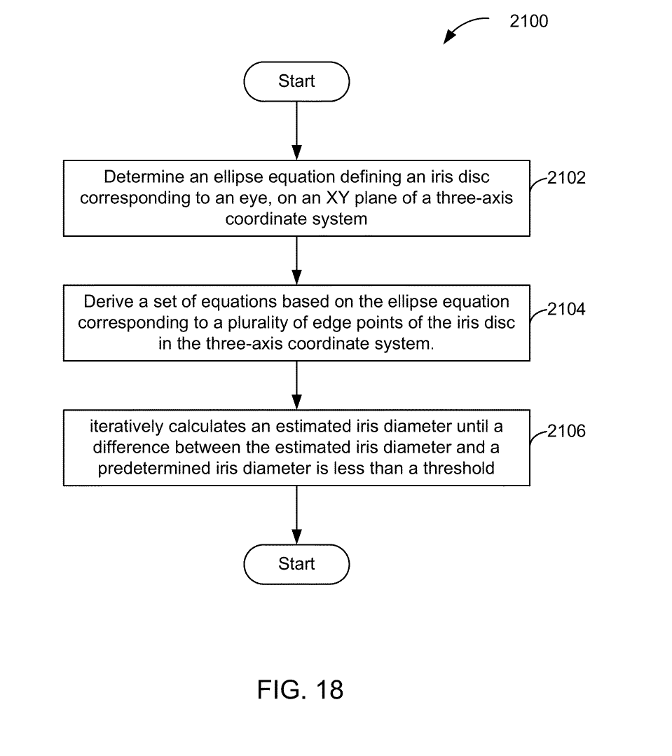

FIGS. 18, 19, and 20 are flowcharts illustrating a method 2100 of iteratively solving a set of elliptic equations to determine an optical axis of an iris disc (e.g., 1200 in FIG. 12) in accordance with an aspect of the disclosure. In one aspect, the method 2100 may be performed by the mobile device 1900 or the computer 2000. In a step 2102, the method determines an ellipse equation defining an iris disc corresponding to an eye, on an XY plane of the three-axis coordinate system. In a step 2104, the method derives a set of equations based on the ellipse equation corresponding to a plurality of edge points of the iris disc in the three-axis coordinate system. In a step 2106, the method iteratively calculates an estimated iris diameter until a difference between the estimated iris diameter and a predetermined iris diameter is less than a threshold. The step 2106 may be include a number processes, for example in FIG. 19: a process 2108 for estimating a ray length from a spatial origin of the three-axis coordinate system to a first edge point of the plurality of edge points; a process 2110 for solving the set of equations based on the estimated ray length to calculate a plurality of solutions; a process 2112 for calculating the estimated iris diameter based on the solutions; and a process 2114 for calculating an optical axis vector of the eye in the three-axis coordinate system based on the solutions.

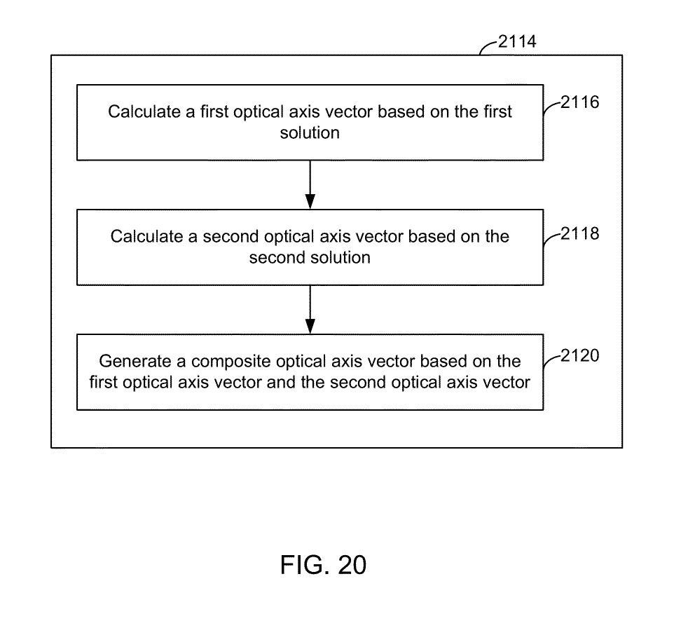

The solutions for the set of equations may include a first solution and a second solution based on two sets of the edge points (e.g., see FIG. 12, a1, a2, and b1 in a first set; a1, a2, and b2 in a second set) respectively. Referring to FIG. 20, in an aspect, the process 2114 may include a process 2116 for calculating a first optical axis vector based on the first solution, a process 2118 for calculating a second optical axis vector based on the second solution; and a process 2120 for generating a composite optical axis vector based on the first optical axis vector and the second optical axis vector.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

It should be noted that the above described iris disc vector calculations assume that the iris is circular or substantially circular. However, in practice, this assumption may not be true in all scenarios. For example, other than image projection errors, which may not be correctable, there are two error sources for which correction is possible. These two sources are image distortion, imparted by the optics, and the fact that human irises are very rarely circles, even when digitized in images, from any aspect or point of view. In an aspect of the disclosure, the algorithm described below can be adapted to correct errors from both sources.

Image distortion can be measured with excellent precision and a suitable correction function may be determined for any camera. For iris disc vector calculations, however, where accuracy is paramount, the correction function cannot be applied to individual edge pixel locations. Any disc edge point (e.g., pixel points 83 in FIG. 7) of an iris projected into a digitized image could actually be positioned anywhere in the pixel up to ✓2 (Pixel pitch)/2 from the center, depending on direction. Although each iris edge pixel may have a small amount of positional error, considered in aggregate, over all iris edge pixels, this positional uncertainty has a significant, negative effect on accurate iris disc vector calculations.

In an aspect, before the correction function is applied, therefore, the raw edge points (e.g., pixel points 83 in FIG. 7) are first fitted to an ellipse in the image plane, as described above in reference to Equations 1 to 8. Once the ellipse parameters for the raw edge points have been determined, a new edge data set is created that is a precise data set that conforms to the ellipse parameters so determined. This new edge data set includes a plurality of the ellipse edge points, e.g., 100-200 points spread around the circumference of the ellipse, calculated using the parameters determined from the fit to the raw edge points. A suitable distortion correction function is then applied to each point in this new data set. Subsequently, a new ellipse is fit (again, as described in reference to Equations 1 to 8) to the corrected points of the new data set, and all iris disc vector calculations (e.g., algorithm 1300 of FIG. 13) proceed from there, using the new ellipse parameters determined by the fit to the corrected edge points.

In a similar fashion, correction can be applied to compensate for iris disc out-of-round. Out-of-round is a short-hand terminology describing the natural shape of virtually every human iris disc. The above-described iris disc vector algorithm (e.g., algorithm 1300) and calculations define, and necessarily assume, that each disc is a circle when the iris disc vector is parallel to the optical axis of the imaging sensor. However, this is typically not the case because an iris disc in reality is generally out-of-round to some extent. This presents as a significant source of error in the optical vector calculations. Therefore, the raw edge points should first be fit to an ellipse in the image plane and a new data set created, which will be described in more detail below.

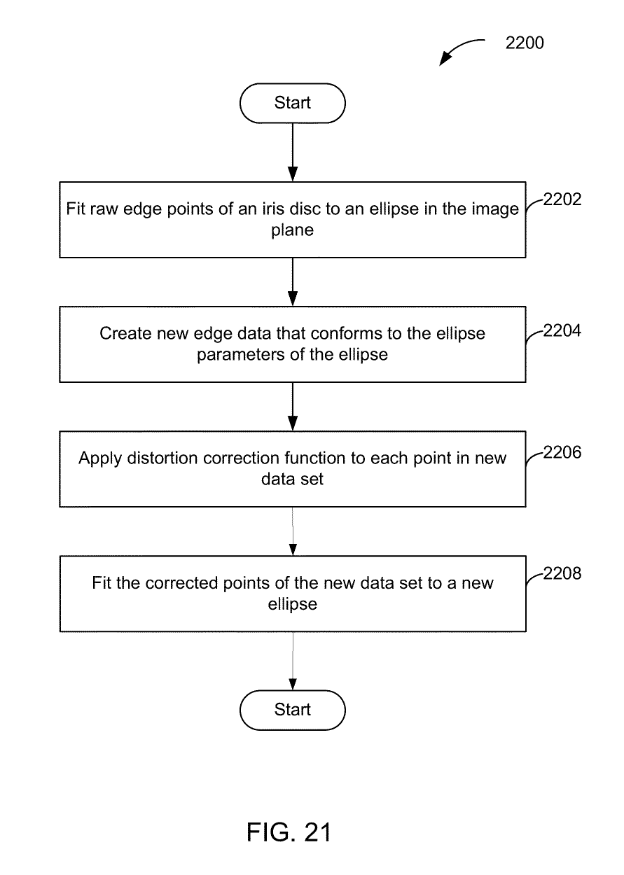

FIG. 21 is a flowchart illustrating an algorithm 2200 for correcting distortion of iris disc image data in accordance with an aspect of the disclosure. The algorithm 2200 may be performed at the mobile device 1900 or computer system 2000. In a step 2202, the raw edge points of an iris disc (e.g., pixel points 83 in FIG. 7) are first fitted to an ellipse in the image plane as described above in reference to Equations 1 to 8. Then, the ellipse parameters are determined for the raw edge points as described above in reference to Equation 8. In a step 2204, a new edge data set is created that conforms to the ellipse parameters so determined. This new edge data set includes a plurality of the ellipse edge points calculated using the parameters determined from the fit to the ellipse. In a step 2206, a suitable distortion correction function is then applied to each point in this new data set. In various aspects, any generally known distortion correction functions may be used depending on the distortion to be corrected. In a step 2208, the corrected points of the new data set are fit to a new ellipse. Then, the above-described disc vector calculations (algorithm 1300) may proceed based on the corrected new data set and new ellipse parameters.

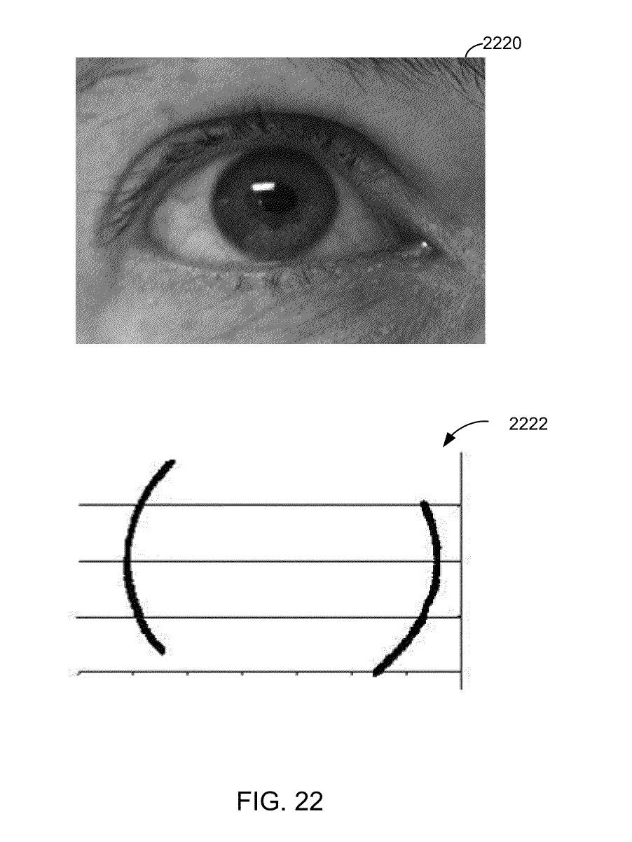

In an aspect of the disclosure, the out-of-round correction will be illustrated below using a real world example. In FIG. 22, a right eye 2220 of a particular subject was imaged, e.g., using camera 11 in FIG. 1, and the corresponding raw edge points data set are plotted in a plot 2222. Data collected from several earlier images, in a variety of aspects (not shown), was used to determine that the iris of this eye 2220 was elliptic (out-of-round) when the subject's iris disc vector was parallel to the imaging sensor's optical axis, with key parameters as follows, for example:

aₑ/bₑ=1.038(constant value for this subject)

α=0.487(constant value for this subject)

These values are not typical, from person to person, but the fact that aₑ does not equal bₑ is overwhelmingly typical for human irises, with the ratio between them varying by degree only. Further, some rotation of the iris disc elliptic shape (said rotation always being measured with respect to a line drawn in the image between the left and right iris center points) is also overwhelmingly typical, for example, varying between ±π/2. Finally, these particular values are constant for this subject, regardless of the position or orientation of this subject's iris disc in images. In the general population, in the rare cases where aₑ/bₑ=1.000 (a possible attribute for particular, but highly atypical, subjects), it is certainly possible that these very few irises need not be corrected for out-of-round. In all other cases, however, correction is needed.

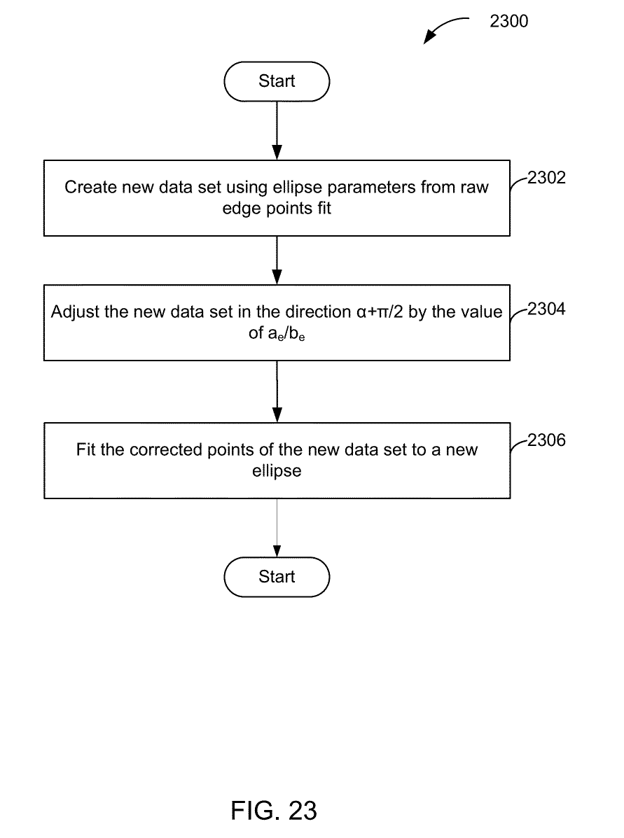

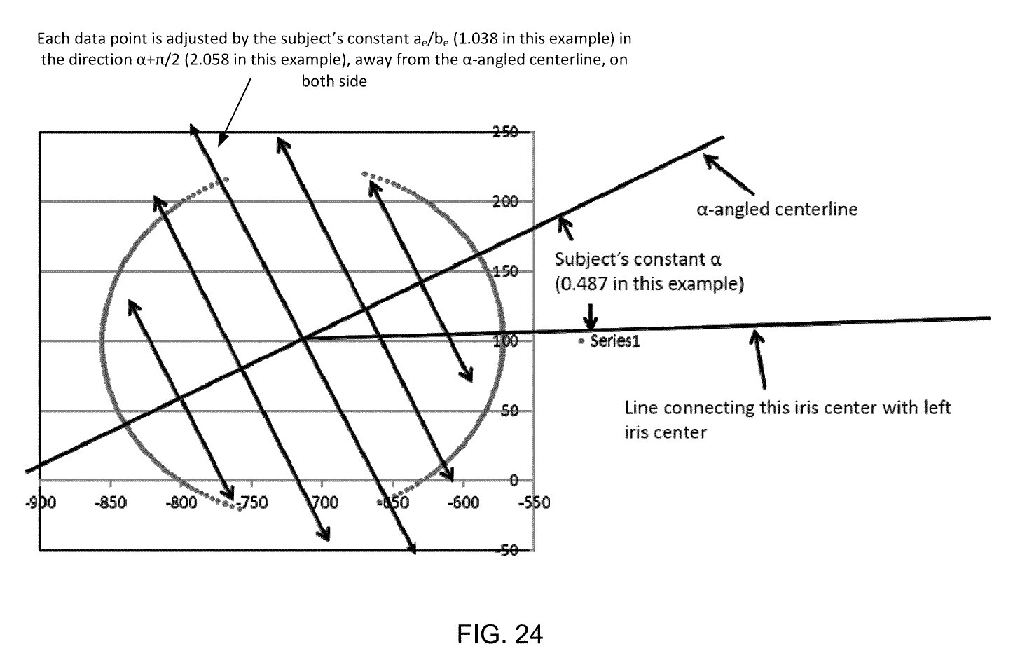

FIG. 23 is a flowchart illustrating an algorithm 2300 for correcting out-of-round iris in accordance with an aspect of the disclosure. In a step 2302, a new data set a created using the ellipse parameters from the raw edge points fit, similar to the fit described in method 2200. In a step 2304, the new data set is adjusted in the direction α+π/2 by the value of aₑ/bₑ. Again, α is measured with respect to a line drawn in the image between the left and right iris center points (see FIG. 24). Imagine a line drawn at the rotation angle, α, through the center of the iris disc ellipse created from the raw data set parameters (as illustrated in FIG. 24). The ellipse points in this data set are adjusted by multiplying the distance of each point from the α-angled centerline by aₑ/bₑ.

In one particular example, an ellipse was first fit to the raw data set shown in FIG. 22, producing the following parameters.

aₑ=141.945

bₑ=125.79

xₒₛ=−713.909

yₒₛ=100.259

α=0.0431

The precision data set created from these parameters was then adjusted as shown in FIG. 24. Each data point was adjusted by the subject's constant aₑ/bₑ (e.g., 1.038) in the direction α+π/2 (e.g., 2.058), away from the α-angled centerline, on both sides. In a step 2306, an ellipse fit to this corrected data set produced a new ellipse with the following parameters, for example, which may be used to calculate the subject's iris disc vector, for example, by the algorithm 1300.

aₑ=143.235

bₑ=129.413

xₒₛ=−713.909

yₒₛ=100.259

α=−0.1027

Looking at the two sets of parameters above, parameter differences are reflected in the ellipse radii ratio (aₑ/bₑ is 1.107 for corrected data, 1.128 for raw) and α (−0.1027 for corrected data, 0.0431 for raw). When the iris disc vector calculated from the corrected parameters was adjusted for this subject's visual axis offset, the resultant visual axis vector exhibited a 0.75° solid angle error from the target point that the subject's gaze was fixed upon when the image was captured. This compares to an error of several degrees for the raw data parameters. Further, as the subject's gaze roams from target point to target point, associated raw data iris disc vectors may exhibit “pointing” errors in uncorrelated directions (as the rotation of the iris disc varies), rendering impossible or difficult the task of determining a constant, and accurate, visual axis offset for the subject. Corrected data iris disc vectors, in contrast, are well behaved, and correlate quite well, allowing for accurate determination of the subject's visual axis offset values.

In the particular example described above, the imaging sensor was virtually distortion-free, to a degree that no distortion correction was required. As in this case, in some aspects, some imaging sensors have so little distortion that correction may not be needed. Otherwise, when correcting for errors from both sources, distortion and out-of-round, first apply the distortion correction function (e.g., algorithm 2200) to the data set created from the raw ellipse parameters. Then, apply the out-of-round correction (e.g., algorithm 2300) to this distortion corrected data set, resulting in a fully corrected data set, from which the final ellipse fit is calculated, providing fully corrected parameters to the iris disc vector calculations.

Various aspects implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage medium may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

When implemented in hardware, the functionality may be implemented within circuitry of a wireless signal processing circuit that may be suitable for use in a wireless receiver or mobile device. Such a wireless signal processing circuit may include circuits for accomplishing the signal measuring and calculating steps described in the various embodiments.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for determining an optical axis vector of an eye in a three-axis coordinate system comprising X, Y and Z axes, comprising:
determining an ellipse equation defining an iris disc corresponding to the eye, on an XY plane of the three-axis coordinate system;
deriving a set of equations based on the ellipse equation corresponding to a plurality of edge points of the iris disc in the three-axis coordinate system; and
iteratively calculating an estimated iris diameter until a difference between the estimated iris diameter and a predetermined iris diameter is less than a threshold, comprising:
estimating a ray length from a spatial origin of the three-axis coordinate system to a first edge point of the plurality of edge points;
solving the set of equations based on the estimated ray length to calculate a plurality of solutions;
calculating the estimated iris diameter based on the solutions; and
calculating an optical axis vector of the eye in the three-axis coordinate system based on the solutions,
wherein the solutions comprise a first solution and a second solution based on two sets of the edge points, respectively, and
wherein calculating the optical axis vector comprises:
calculating a first optical axis vector based on the first solution,
calculating a second optical axis vector based on the second solution; and
generating a composite optical axis vector based on the first optical axis vector and the second optical axis vector.

2. The method of claim 1, wherein the set of equations corresponds to a center point of the iris disc and at least three edge points of the plurality of edge points including the first edge point.

3. The method of claim 2, wherein the at least three edge points comprise end points of a major axis and at least one end point of a minor axis of the iris disc.

4. The method of claim 1,
wherein the first solution corresponds to end points of a major axis of the iris disc and a first end point of a minor axis of the iris disc; and
wherein the second solution corresponds to the end points of the major axis and a second end point of the minor axis.

5. The method of claim 4,
wherein the end points of the major axis correspond to a first point (x₁, y₁, z₁) and a second point (x₂, y₂, z₂) in the three-axis coordinate system, respectively,
wherein the first or second end point of the minor axis corresponds to a third point (x₃, y₃, z₃) in the three-axis coordinate system, and
wherein the set of equations comprises:
2iᵣ²=(Aₓ₁M₁−Aₓ₃M₃)²+(A_{y1}M₁−A_{y3}M₃)²+(A_{z1}M₁−A_{z3}M₃)²,
2iᵣ²=(Aₓ₂M₂−Aₓ₃M₃)²+(A_{y2}M₂−A_{y3}M₃)²+(A_{z2}M₂−A_{z3}M₃)²,
4iᵣ²=(Aₓ₁M₁−Aₓ₂M₂)²+(A_{y1}M₁−A_{y2}M₂)²+(A_{z1}M₁−A_{z2}M₂)²,
where
iᵣ=iris radius,
x₁=M₁ sin φ₁ cos θₐ₁=Aₓ₁M₁,
y₁=M₁ sin φ₁ sin θₐ₁=A_{y1}M₁,
z₁=M₁ cos φ₁=A_{z1}M₁,
M₁ is a ray length between the spatial origin and the first point (x₁, y₁, z₁),
φ₁ and θₐ₁ are angles associated with the first point (x₁, y₁, z₁) and the ray length M₁ in the three-axis coordinate system;
x₂=M₂ sin φ₂ cos θₐ₂=Aₓ₂M₂,
y₂=M₂ sin φ₂ sin θₐ₂=A_{y2}M₂,
z₂=M₂ cos φ₂=A_{z2}M₂,
M₂ is a ray length between the spatial origin and the second point (x₂, y₂, z₂),
φ₂ and θₐ₂ are angles associated with the second point (x₂, y₂, z₂) and the ray length M₂ in the three-axis coordinate system; and
x₃=M₃ sin φ₃ cos θ_{b1}=Aₓ₃M₃,
y₃=M₃ sin φ₃ sin θ_{b1}=A_{y3}M₃,
z₃=M₃ cos φ₃=A_{z3}M₃,
M₃ is a ray length between the spatial origin and the third point (x₃, y₃, z₃),
φ₃ and θₐ₃ are angles associated with the third point (x₃, y₃, z₃) and the ray length M₃ in the three-axis coordinate system.

6. The method of claim 5,
wherein estimating a ray length comprises estimating two values of the ray length M₃, and
wherein solving the set of equations comprises:
calculating the plurality of solutions based on the estimated values of the ray length M₃; and
determining a slope for a plurality of solution curves corresponding to the plurality of solutions.

7. The method of claim 6,
wherein calculating the iris diameter comprises calculating a spatial distance between the first point and the second point based on the solutions, and
wherein iteratively calculating an estimated iris diameter further comprises adjusting the estimated values of the ray length M₃ based on a difference between the estimated iris diameter and the predetermined iris diameter.

8. The method of claim 1,
wherein the plurality of edge points comprise a first end point and a second end point of a major axis of the iris disc, and
the method further comprising:
determining spatial coordinates of the first and second end points in the three-axis coordinate system based on the solution; and
determining spatial coordinates of a center point of the iris disc in the ellipse based on the solution.

9. The method of claim 8, wherein calculating an optical axis vector of the eye comprises:
calculating a first vector involving the center point and the first end point;
calculating a second vector involving the center point and the second end point; and
calculating the optical axis vector as a cross product between the first vector and the second vector.

10. The method of claim 1,
wherein determining the ellipse equation comprises:
fitting a plurality of first edge points of the iris disc to a first ellipse;
generating a plurality of second edge points based on ellipse parameters of the first ellipse;
correcting the second edge points for at least one of image distortion or out-of-round iris; and
fitting the corrected second edge points to a second ellipse, and
wherein calculating the optical axis vector comprises utilizing ellipse parameters of the second ellipse to calculate the optical axis vector of the eye.

11. The method of claim 10, wherein correcting the second edge points comprises applying a distortion function on the second edge points.

12. The method of claim 10, wherein correcting the second edge points comprises:
adjusting each point of the second edge points in a direction α+π/2 by a value corresponding to a ratio of a major axis and a minor axis of the iris disc,
wherein α is measured with respect to a line drawn in the iris disc between left and right iris center points, and aₑ is the major axis and bₑ is a minor axis of the iris disc, and
wherein α and aₑ/bₑ are the out-of-round constants for the eye.

13. A computing device, comprising:
a digital camera; and
a processor coupled to the camera and configured with processor-executable instructions to perform operations comprising:
obtaining a digital image of an eye with the digital camera;
processing the digital image to determine an optical axis vector of the eye in a three-axis coordinate system comprising X, Y and Z axes, wherein the processing comprises:
determining an ellipse equation defining an iris disc corresponding to the eye, on an XY plane of the three-axis coordinate system;
deriving a set of equations based on the ellipse equation corresponding to a plurality of edge points of the iris disc in the three-axis coordinate system; and
iteratively calculating an estimated iris diameter until a difference between the estimated iris diameter and a predetermined iris diameter is less than a threshold, comprising:
estimating a ray length from a spatial origin of the three-axis coordinate system to a first edge point of the plurality of edge points;
solving the set of equations based on the estimated ray length to calculate a plurality of solutions;
calculating the estimated iris diameter based on the solutions; and
calculating an optical axis vector of the eye in the three-axis coordinate system based on the solutions,
wherein the solutions comprise a first solution and a second solution based on two sets of the edge points, respectively, and
wherein calculating the optical axis vector comprises:
calculating a first optical axis vector based on the first solution, calculating a second optical axis vector based on the second solution; and
generating a composite optical axis vector based on the first optical axis vector and the second optical axis vector.

14. The computing device of claim 13,
wherein determining the ellipse equation comprises:
fitting a plurality of first edge points of the iris disc to a first ellipse;
generating a plurality of second edge points based on ellipse parameters of the first ellipse;
correcting the second edge points for at least one of image distortion or out-of-round iris; and
fitting the corrected second edge points to a second ellipse, and
wherein calculating the optical axis vector comprises utilizing ellipse parameters of the second ellipse to calculate the optical axis vector of the eye.

15. The computing device of claim 14, wherein correcting the second edge points comprises applying a distortion function on the second edge points.

16. The computing device of claim 14, wherein correcting the second edge points comprises:
adjusting each point of the second edge points in a direction α+π/2 by a value corresponding to a ratio of a major axis and a minor axis of the iris disc,
wherein α is measured with respect to a line drawn in the iris disc between left and right iris center points, and aₑ is the major axis and bₑ is a minor axis of the iris disc, and
wherein α and aₑ/bₑ are the out-of-round constants for the eye.

17. A computing device, comprising:
means for obtaining a digital image of an eye; and
means for processing the digital image to determine an optical axis vector of the eye in a three-axis coordinate system comprising X, Y and Z axes, wherein the means for processing comprises:
means for determining an ellipse equation defining an iris disc corresponding to the eye, on an XY plane of the three-axis coordinate system;
mean for deriving a set of equations based on the ellipse equation corresponding to a plurality of edge points of the iris disc in the three-axis coordinate system; and
means for iteratively calculating an estimated iris diameter until a difference between the estimated iris diameter and a predetermined iris diameter is less than a threshold, comprising:
means for estimating a ray length from a spatial origin of the three-axis coordinate system to a first edge point of the plurality of edge points;
means for solving the set of equations based on the estimated ray length to calculate a plurality of solutions;
means for calculating the estimated iris diameter based on the solutions; and
means for calculating an optical axis vector of the eye in the three-axis coordinate system based on the solutions,
wherein the solutions comprise a first solution and a second solution based on two sets of the edge points, respectively, and
wherein the means for calculating the optical axis vector comprises:
means for calculating a first optical axis vector based on the first solution,
means for calculating a second optical axis vector based on the second solution; and
means for generating a composite optical axis vector based on the first optical axis vector and the second optical axis vector.

18. The computing device of claim 17,
wherein the means for determining the ellipse comprises:
means for fitting a plurality of first edge points of the iris disc to a first ellipse;
means for generating a plurality of second edge points based on ellipse parameters of the first ellipse;
means for correcting the second edge points for at least one of image distortion or out-of-round iris; and
means for fitting the corrected second edge points to a second ellipse, and
wherein the means for calculating the optical axis vector comprises means for utilizing ellipse parameters of the second ellipse to calculate the optical axis vector of the eye.

19. The computing device of claim 18, wherein means for correcting the second edge points comprises means for applying a distortion function on the second edge points.

20. The computing device of claim 18, wherein means for correcting the second edge points comprises:
means for adjusting each point of the second edge points in a direction α+π/2 by a value corresponding to a ratio of a major axis and a minor axis of the iris disc,
wherein α is measured with respect to a line drawn in the iris disc between left and right iris center points, and aₑ is the major axis and bₑ is a minor axis of the iris disc, and
wherein α and aₑ/bₑ are the out-of-round constants for the eye.

21. A non-transitory processor-readable storage medium having stored thereon processor-executable instructions configured to cause a processor of a computing device including a digital camera to perform operations comprising:
obtaining a digital image of an eye with the digital camera; and
processing the digital image to determine an optical axis vector of the eye in a three-axis coordinate system comprising X, Y and Z axes, wherein the processing comprises:
determining an ellipse equation defining an iris disc corresponding to the eye, on an XY plane of the three-axis coordinate system;
deriving a set of equations based on the ellipse equation corresponding to a plurality of edge points of the iris disc in the three-axis coordinate system; and
iteratively calculating an estimated iris diameter until a difference between the estimated iris diameter and a predetermined iris diameter is less than a threshold, comprising:
estimating a ray length from a spatial origin of the three-axis coordinate system to a first edge point of the plurality of edge points;
solving the set of equations based on the estimated ray length to calculate a plurality of solutions;
calculating the estimated iris diameter based on the solutions; and
calculating an optical axis vector of the eye in the three-axis coordinate system based on the solutions,
wherein the solutions comprise a first solution and a second solution based on two sets of the edge points, respectively, and
wherein calculating the optical axis vector comprises:
calculating a first optical axis vector based on the first solution,
calculating a second optical axis vector based on the second solution; and
generating a composite optical axis vector based on the first optical axis vector and the second optical axis vector.

22. The non-transitory processor-readable storage medium of claim 21,
wherein determining the ellipse equation comprises:
fitting a plurality of first edge points of the iris disc to a first ellipse;
generating a plurality of second edge points based on ellipse parameters of the first ellipse;
correcting the second edge points for at least one of image distortion or out-of-round iris; and
fitting the corrected second edge points to a second ellipse, and
wherein calculating the optical axis vector comprises utilizing ellipse parameters of the second ellipse to calculate the optical axis vector of the eye.

23. The non-transitory processor-readable storage medium of claim 22, wherein correcting the second edge points comprises applying a distortion function on the second edge points.

24. The non-transitory processor-readable storage medium of claim 22, wherein correcting the second edge points comprises:
adjusting each point of the second edge points in a direction α+π/2 by a value corresponding to a ratio of a major axis and a minor axis of the iris disc,
wherein α is measured with respect to a line drawn in the iris disc between left and right iris center points, and aₑ is the major axis and bₑ is a minor axis of the iris disc, and
wherein α and aₑ/bₑ are the out-of-round constants for the eye.
